(19) United States
(12) Patent Application Publication
(10) Pub. No.: US 2022/0345371 A1
(43) Pub. Date: Oct. 27, 2022

(54) CONTROL CONFIGURATION FOR A PLURALITY OF ENDPOINT DEVICES

(71) Applicant: SNAPT, INC, San Jose, CA (US)

(72) Inventors: David Michael Blakey, Cape Town (ZA); Mark Graeme Trent, Cape Town (ZA); Willem Nicolaas Van Der Schyff, Cape Town (ZA)

(21) Appl. No.: 17/620,453

(22) PCT Filed: Jun. 19, 2020
(86) PCT No.: PCT/IB2020/055795

§ 371 Date: Dec. 17, 2021

Related U.S. Application Data
(60) Provisional application No. 62/865,091, filed on Jun. 21, 2019.

(51) Int. Cl. H04L 41/12; H04L 67/141; H04L 9/40

(52) U.S. Cl. CPC H04L 41/12; H04L 67/141; H04L 63/0428

(57) ABSTRACT

There is provided a system and method for controlling a plurality of endpoint devices. Multiple connection requests, each connection request originating from an endpoint device are received by a server. Each endpoint device has a client interface thereat that generates the connection request as an outbound connection request from the endpoint device to the server computer. A persistent data communication session is established between the server computer and the client interface of each endpoint device. Command data is received to control one or more of the endpoint devices. The server computer generates a data packet including the command data and transmits the data packet via the persistent data communication session to the endpoint device, to enable the endpoint device instructions to be carried out by the endpoint device, and result data is then received by the server once the instructions are carried out.

### CROSS-REFERENCE TO RELATED APPLICATION

This application claims priority from U.S. provisional patent application No. 62/865,091 filed on 21 Jun. 2019, which is incorporated by reference herein.

### FIELD OF ART

This disclosure relates to data processing. More particularly, but not exclusively, this disclosure relates to a system and method for controlling a plurality of endpoint devices in a digital network.

### BACKGROUND

With the advent of the Internet of Things (IoT), data processing has become an ever-increasing problem. There have been a proliferation of endpoint devices that are IoT capable and Internet connectivity is already an integral feature of many devices which are remotely monitored and controlled. These devices have various applications and range from household appliances to smart vehicles, wearable devices and many others. These endpoint devices are often mobile and generally use dynamic Internet Protocol (IP) addresses that change over time, or as the device moves from one network to the next. This is particularly prevalent in mobile devices that communicate using Global System for Mobile communications (GSM), third generation (3G), fourth generation (4G), Long-Term Evolution (LTE), LTE Advanced, as well as IoT devices that utilize IoT specialized wireless communication technologies.

However, even for fixed line connections such as Asymmetric digital subscriber line (ADSL) and Fiber to the x (FTTX) connections, IP addresses assigned to IoT endpoint devices are often dynamic and change over time, for example when the device moves from one wireless or wired Internet link to the other, or when IP configuration settings of the device change for some reason. Transmission of data to these devices thus quickly becomes problematic at a larger scale, because these changing IP addresses cause a substantial server load, and immense computing power is needed to keep track of all the IoT devices. It is estimated that there are already billions of IoT endpoint devices and this number is rapidly increasing.

Firewalls in local networks further exacerbate the problem and communications that are initiated at a server side become computationally prohibitive when these vast numbers of devices need to be monitored, tracked or controlled. As result, communications between servers and IoT devices are slow and often have a high latency.

As an example, when an operator of smart vehicles intends to send firmware updates from its servers to millions of its smart vehicles, or when the operator needs to perform polling of their vehicles, this process would take hours or even days to complete, because of a bottleneck that is caused by the aforementioned problems. Long-polling is typically used, where a placeholder connection is opened in anticipation of an instruction, however this results in loss of efficacy where many instructions are required to be sent over a connection because the connection still needs to be securely established every time when a new instruction is initiated. Real-time communication between servers and IoT endpoint devices at a large scale is thus not possible, is impractical, or is prohibitively expensive with currently available technologies.

Further problems arise when the IoT devices are battery-powered, as any inefficiencies within the components of an IoT device may cause a faster depletion of the battery. IoT devices may also lose Internet connectivity for other reasons, such as when a wireless communication link is interrupted for some reason, for example while driving through a tunnel or when the endpoint device is located in an area with limited or no Internet connectivity. Alternatively, they may be mobile devices which change connection methods constantly. In these circumstances, servers may utilize unnecessary or wasteful computational power in attempts to locate offline IoT devices. When the IoT devices come back online, their IP address, firewall settings and location may have changed which increases server load even more.

Moreover, further problems arise in distributed computing devices and servers such as application delivery controllers (ADC's) or virtual servers that are not necessarily IoT devices. These devices are remotely controlled over a digital network and have the same types of problems with IP addresses that can change regularly and at large scale, for example, when a new set of more than one thousand ADC systems are redeployed with dynamic network discovery. Dynamic network discovery allows servers to be deployed without statically defining specific networking elements, but to rather have those elements be discovered and applied from a controlling server, in this case a Dynamic Host Configuration Protocol (DHCP). Similar situations exist on container platforms like Docker and Kubernetes, and in public cloud environments with non-static IPs. Keeping track of large numbers of these devices also requires a vast amount of computational resources. There are protocols and remote monitoring services currently available, however none of these known systems or methods that the applicant is aware of addresses or solves the aforementioned problems. Known protocols tend to take more time to establish a secure connection than the time that is actually needed to perform an instruction, for example when Transport Layer Security (TLS) is used. Hence, the known systems do not provide for near real-time communications with large numbers of endpoint devices, they lack scalability and are generally inefficient and unsuited for applications that require a hyper-scale.

There is accordingly scope to address the aforementioned problems and deficiencies, or at least to provide a useful alternative to the known systems and methods.

The preceding discussion is not an acknowledgment or admission that any of the material referred to was part of the common general knowledge in the art as at the priority date of the application.

### SUMMARY

In accordance with an aspect of the disclosed embodiments there is provided a computer-implemented method for controlling a plurality of endpoint devices, the method being conducted at a server computer, the method comprising:
receiving, by the server computer, multiple connection requests, each connection request originating from an endpoint device, each endpoint device having a client interface thereat that generates the connection request as an outbound connection request from the endpoint device to the server computer;
establishing, by the server computer, a persistent data communication session between the server computer and the client interface of each endpoint device;
receiving, through a control interface of the server computer, command data to control one or more of the endpoint devices, the command data including endpoint device instructions and endpoint device identifiers;
for each endpoint device identified by the received endpoint device identifiers:
   generating, by the server computer, a data packet including the command data;
   transmitting, by the server computer, the data packet via the persistent data communication session to the client interface of the endpoint device, to enable the endpoint device instructions to be carried out by the endpoint device; and
   receiving, by the server computer, result data from the client interface of the endpoint device once the instructions are carried out.

Further features may provide for the client interface of each endpoint device to be configured, once a connection between the client interface and the server computer is lost, to automatically transmit another outbound connection request for the server computer to reconnect or re-establish the persistent data communication session.

Still further features may provide for the client interface to be configured to repetitively attempt to re-establish the persistent data communication session, for the repetitive attempts to occur at intervals of once per second, or at increasing intervals of about 1, 2, 3, 4, 5, 6, 7, 8, 9, or up to 10 seconds, and may continue to attempt to connect at 10 second intervals, or at any other suitable interval.

Yet further features may provide for the client interface to be a standard client interface; for the standard client interface to be downloaded onto the endpoint device from the server computer; alternatively, for the standard client interface to be installed onto the endpoint device during manufacture of the endpoint device.

Further features may provide for the server computer to form part of, or to be connected to a customer cloud infrastructure that includes a plurality of other server computers that each carry out the steps of the method.

Still further features may provide for the customer cloud infrastructure to be in data communication with the control interface of the server computer using an application programming interface (API), for example using a representational state transfer (REST) API or RESTful API.

Yet further features may provide for the endpoint device instructions to be configured to cause a processor associated with the endpoint device to carry out the endpoint device instructions; for the endpoint device instructions to include any one or more of a read command, a write command and a run or execute command; for data, such as larger data files, to be transferred from the endpoint device to the server computer or vice versa during the persistent data communication session; and for data files to be transferred in portions or by using a chunking process.

Further features may provide for one or both of the data packet and the result data to be time stamped; for the result data to include an indication of whether the endpoint device instructions were carried out successfully or not; for the result data to include error data if the endpoint device instructions were not carried out successfully.

A still further feature may provide for the method to include transmitting, by the server computer, the result data to the customer cloud infrastructure for further processing.

Yet further features may provide for the method to include: receiving, through the control interface of the server computer, a list of the endpoint device identifiers from the customer for storage in a database associated with the server computer; accessing, by the server computer, the list in the database to retrieve each endpoint device identifier therefrom, to include it in the data packet destined for that endpoint device during the persistent data communication session; for the server computer to be arranged to utilize a look-up table, or the like, to retrieve the endpoint device identifier from the list.

Further features may provide for the method to include: encrypting, by the server computer, the data packet; causing the client interface of the endpoint device to decrypt the data packet; causing the client interface of the endpoint device to encrypt the result data; and decrypting, by the server computer, the result data when it is received from the client interface of the endpoint device during the persistent data communication session.

Still further features may provide for the plurality of endpoint devices to form part of an Internet of Things (IoT) network; for the IoT network to be controlled by the server computer; and for the plurality of endpoint devices to be associated with the customer.

Yet further features may provide for the plurality of server computers to be arranged in one or more server clusters; for the plurality of server computers to provide server redundancy.

Further features may provide for the communications to be provided by a communications protocol; for the communications protocol to be a unicast protocol; for the communications protocol to include a set of rules that governs communications between the server computer and the client interface of each endpoint device.

Still further features may provide for the set of rules to include any one or more of the following:
that only endpoint device instructions originating from the customer are to be carried out by one or more of the endpoint devices, or by an intended endpoint device or devices;
that the data packet can only be received from the server computer during the persistent data communication session;
that only a data packet received from the server computer and including a unique endpoint device identifier is able to be utilized by that endpoint device;
that the endpoint device is only able to transmit the result data to the server computer if the received data packet includes instructions originating from the server computer; and
that the endpoint device is only able to transmit the result data to the server computer if the result data is a directly derivable result of the endpoint device instructions.

Yet further features may provide for the communications between the customer cloud infrastructure and the server computer, as well as between the server computer and the client interface of the endpoint device to be provided by a secure communications link, for example by way of Hypertext Transfer Protocol Secure (HTTPS) utilizing Secure Sockets Layer (SSL) or Transport Layer Security (TLS), or any other cryptographic protocol, including asymmetric cryptography that utilizes public and private key pairs; for the communications to be provided by HTTP or HTTPS tunneling technology; alternatively, for the communications to be provided by User Datagram Protocol (UDP), or any other protocol.

Further features may provide for the method to include: authenticating, by the server computer, the endpoint device before establishing the persistent data communication session with the client interface of that endpoint device.

Still further features may provide for the method to include performing, by the server computer, a handshake process or authentication process between the server computer and the client interface of the endpoint device to initiate the persistent data communication session; for the persistent data communication session to be a secure link which is established or negotiated, after which the server computer may transmit the data packet via the persistent data communication session to the client interface of the endpoint device, so that subsequent responses and data packets may be sent and received without requiring the persistent data communications session or secure link to be re-negotiated.

Yet further features may provide for the handshake process or authentication process to be performed in less than a second; alternatively, in less than 500 milliseconds (ms), and preferably in about 150 milliseconds, or less than 150 milliseconds; for the persistent data communication session to be a bi-directional session that enables communication between the server computer and the client interface of the endpoint device; for the persistent data communication session to enable the step of transmitting, by the server computer, the data packet via the persistent data communication session to the client interface of the endpoint device within less than 100 milliseconds, and preferably within about 25 milliseconds or within about 5 milliseconds; alternatively, for a latency of the bi-directional persistent data communication session to be about 5 milliseconds, excluding a round trip time (RTT).

Further features may provide for the client interface of each endpoint device to be client software operated on the endpoint device; for the client software to be hard coded; for the client software to be installed during manufacture of each endpoint device; for the client interface to be configured such that any endpoint device that includes the client interface thereat is required to comply with the set of rules which may be described by the client interface, alternatively for the client software to be downloaded from the server computer and/or dynamically updated during the persistent data communication session.

Still further features may provide for the client interface of the endpoint device to be configured, if the data packet is received and the persistent data communication session is subsequently terminated, to nevertheless cause the endpoint device to carry out the endpoint device instructions, and then to transmit the result data once the persistent data communication session is re-established.

Yet further features may provide for the method to include: controlling, by the server computer, each endpoint device in near real-time; for the method to include implementing, by the server computer or the customer cloud infrastructure, a machine learning algorithm, static logic or other event to react in near real-time to result data received from one or more of the plurality of endpoint devices.

Further features may provide for the server computer to be a physical server or a virtual server.

Still further features may provide for the client interface of each endpoint device to be a thin client; and for the control interface of the server computer to be a thin server.

Further features may provide for the thin client to be configured to pull data from the thin server; for the thin client to occupy less than 100 megabytes, alternatively less than 10 megabytes of storage space on a memory associated with each endpoint device; for the thin server to occupy less than 100 megabytes, alternatively less than 10 megabytes of storage space on a memory associated with the server computer; for server computer to be endpoint-agnostic; and for the client interface of each endpoint device to be endpoint-agnostic excluding the memory required for a given instruction and contents of any packets or files within.

In accordance with another aspect of the disclosure there is provided a computer-implemented method for controlling a plurality of endpoint devices, the method being conducted at an endpoint device, the method comprising:
providing a client interface at the endpoint device;
generating, by the client interface of the endpoint device, an outbound connection request from the endpoint device to the server computer, to cause the server computer to establish a persistent data communication session between the server computer and the client interface of the endpoint device;
receiving, by the client interface of the endpoint device, a data packet from the server computer via the persistent data communication session, the data packet including command data to control the endpoint device, the command data including endpoint device instructions and an endpoint device identifier;
carrying out the endpoint device instructions, by a processor of the endpoint device; and
transmitting, by the client interface of the endpoint device, result data to the server computer once the instructions are carried out.

Further features may provide for the client interface of the endpoint device to be configured, once a connection between the client interface and the server computer is lost, to automatically transmit another outbound connection request for the server computer to reconnect or re-establish the persistent data communication session.

Still further features may provide for the client interface to be configured to repetitively attempt to re-establish the persistent data communication session, for the repetitive attempts to occur at intervals of once per second, or at increasing intervals of about 1, 2, 3, 4, 5, 6, 7, 8, 9, or up to 10 seconds and may continue to attempt to connect at 10 second intervals, or at any other suitable interval.

In accordance with a further aspect of the disclosure there is provided a system for controlling a plurality of endpoint devices, the system comprising:
a server computer in data communication with the plurality of endpoint devices, each of the endpoint devices including a client interface configured to generate a connection request as an outbound connection request from the endpoint device to the server computer;
the server computer including:
   a control interface configured to receive command data to control one or more of the endpoint devices, the command data including endpoint device instructions and endpoint device identifiers;
   a receiving component for receiving multiple connection requests, each connection request originating from an endpoint device identified by the received endpoint device identifiers, the server computer being operable, responsive to receiving the connection request of each endpoint device, to establish a persistent data communication session between the server computer and the client interface of the endpoint device;
   a data packet generation component for generating a data packet including the command data; and
   a data packet transmitting component operable to transmit the data packet via the persistent data communication session to the client interface of each endpoint device identified by the endpoint device identifiers, to enable the endpoint device instructions to be carried out by the endpoint device.

A further feature may provide for the system to include a result analytics component provided at the server computer, the result analytics component being operable to analyze result data received by the receiving component from the client interface of the endpoint device, once the instructions are carried out.

Still further features may provide for the client interface of each endpoint device to be configured, once a connection between the client interface and the server computer is lost, to automatically transmit another outbound connection request for the server computer to re-establish the persistent data communication session; for the client interface to be a standard client interface which is downloaded onto the endpoint device from the server computer, or installed onto the endpoint device during manufacture of the endpoint device; for the server computer to form part of, or to be connected to a customer cloud infrastructure that includes a plurality of other server computers; for the endpoint device instructions include any one or more of a read command, a write command and a run command; for data to be transferred to the endpoint device during the persistent data communication session, using a chunking process; for one or both of the data packet and the result data are time stamped; for the result data to include an indication of whether the endpoint device instructions were carried out successfully or not; for the server computer to be configured to encrypt the data packet; and for the client interface of the identified endpoint device to be configured to decrypt the data packet.

Yet further features may provide for the communication to be provided by a communications protocol; for the communications protocol to include a set of rules that governs communications between the server computer and the client interface of each endpoint device; for the set of rules to include any one or more of:
that only endpoint device instructions originating from a specific customer are to be carried out by an intended endpoint device or devices;
that the data packet can only be received from the server computer during the persistent data communication session;
that only a data packet received from the server computer and including a unique endpoint device identifier is able to be utilized by that endpoint device;
that the endpoint device is only able to transmit the result data to the server computer if the received data packet includes instructions originating from the server computer; and
that the endpoint device is only able to transmit the result data to the server computer if the result data is a directly derivable result of the endpoint device instructions.

Further features may provide for the communications during the persistent data communication session to be provided by HTTP or HTTPS tunneling technology; for the server computer to be configured to authenticate the endpoint device before establishing the persistent data communication session with the client interface of that endpoint device, so that subsequent responses and data packets may be sent and received without requiring the persistent data communication session to be re-negotiated; for the authentication process to be performed in less than a second, alternatively, in less than 500 milliseconds (ms), alternatively in about 150 milliseconds; for the client interface of the endpoint device to be configured, if the data packet is received and the persistent data communication session is subsequently terminated, to nevertheless cause the endpoint device to carry out the endpoint device instructions, and then to transmit the result data once the persistent data communication session is re-established; for the server computer to be configured to control each endpoint device in near real-time; for the server computer or the customer cloud infrastructure to be configured to implement a machine learning algorithm to react in near real-time to result data received from one or more of the plurality of endpoint devices; for the client interface of each endpoint device to be a thin client; for the control interface of the server computer to be a thin server; for the thin client to occupy less than 100 megabytes, alternatively less than 10 megabytes of storage space on a memory associated with each endpoint device; and for the thin server to occupy less than 100 megabytes, alternatively less than 10 megabytes of storage space on a memory associated with the server computer.

In accordance with a further aspect of the disclosure there is provided a computer program product for controlling a plurality of endpoint devices, the computer program product comprising a non-transitory computer-readable medium having stored computer-readable program code for performing the steps of:
receiving, by a server computer, multiple connection requests, each connection request originating from an endpoint device, each endpoint device having a client interface thereat that generates the connection request as an outbound connection request from the endpoint device to the server computer;
establishing, by the server computer, a persistent data communication session between the server computer and the client interface of each endpoint device;
receiving, through a control interface of the server computer, command data to control one or more of the endpoint devices, the command data including endpoint device instructions and endpoint device identifiers;
for each endpoint device identified by the received endpoint device identifiers:
   generating, by the server computer, a data packet including the command data;
   transmitting, by the server computer, the data packet via the persistent data communication session to the client interface of the endpoint device, to enable the endpoint device instructions to be carried out by the endpoint device; and
   receiving, by the server computer, result data from the client interface of the endpoint device once the instructions are carried out.

Further features may provide for the computer-readable medium to be a non-transitory computer-readable medium and for the computer-readable program code to be executable by a processor associated with the server computer, or a processor associated with the endpoint device.

Still further features may provide for the client interface to be a standard client interface which is downloaded onto the endpoint device from the server computer, or installed onto the endpoint device during manufacture of the endpoint device; for the client interface of each endpoint device to be configured, once a connection between the client interface and the server computer is lost, to automatically transmit another outbound connection request for the server computer to re-establish the persistent data communication session; for the endpoint device instructions to include any one or more of a read command, a write command and a run command; for data to be transferred to the endpoint device during the persistent data communication session, using a chunking process; for one or both of the data packet and the result data to be time stamped; for the result data to include an indication of whether the endpoint device instructions were carried out successfully or not; for the computer-readable program code to be further configured to perform the steps of: encrypting, by the server computer, the data packet, and causing the client interface of the endpoint device to decrypt the data packet.

Yet further features may provide for the computer-readable program code to be further configured to perform the steps of: causing the client interface of the endpoint device to encrypt the result data, and decrypting, by the server computer, the result data when it is received from the client interface of the endpoint device during the persistent data communication session.

Further features may provide for the communication to be provided by a communications protocol; for the communications protocol to include a set of rules that governs communications between the server computer and the client interface of each endpoint device; and for the set of rules includes any one or more of:
that only endpoint device instructions originating from a specific customer are to be carried out by an intended endpoint device or devices;
that the data packet can only be received from the server computer during the persistent data communication session;
that only a data packet received from the server computer and including a unique endpoint device identifier is able to be utilized by that endpoint device;
that the endpoint device is only able to transmit the result data to the server computer if the received data packet includes instructions originating from the server computer; and
that the endpoint device is only able to transmit the result data to the server computer if the result data is a directly derivable result of the endpoint device instructions.

Still further features may provide for the computer-readable program code to be further configured such that communications during the persistent data communication session is provided by HTTP or HTTPS tunneling technology; for the computer-readable program code to be further configured to perform the steps of: authenticating, by the server computer, the endpoint device before establishing the persistent data communication session with the client interface of that endpoint device, so that subsequent responses and data packets may be sent and received without requiring the persistent data communication session to be re-negotiated.

Yet further features may provide for the authentication process to be performed in less than a second, alternatively, in less than 500 milliseconds (ms), alternatively in about 150 milliseconds; for the client interface of the endpoint device to be configured, if the data packet is received and the persistent data communication session is subsequently terminated, to nevertheless cause the endpoint device to carry out the endpoint device instructions, and then to transmit the result data once the persistent data communication session is re-established; and for the computer-readable program code to be further configured to perform the step of: controlling, by the server computer, each endpoint device in near real-time.

A further feature may provide for the computer-readable program code to be further configured to perform the step of: implementing, by the server computer, a machine learning algorithm to react in near real-time to result data received from one or more of the plurality of endpoint devices.

Still further features may provide for the client interface of each endpoint device to be a thin client; for the control interface of the server computer to be a thin server; for the thin client to occupy less than 100 megabytes, alternatively less than 10 megabytes of storage space on a memory associated with each endpoint device; and for the thin server to occupy less than 100 megabytes, alternatively less than 10 megabytes of storage space on a memory associated with the server computer.

Embodiments of the disclosure will now be described, by way of example only, with reference to the accompanying drawings.

### BRIEF DESCRIPTION OF THE DRAWINGS

In the drawings:

FIG. 1 is a high-level block diagram showing an exemplary implementation of a system for controlling a plurality of endpoint devices;

FIG. 2 is a high-level block diagram similar to FIG. 1, however showing an example use of the system by a major digital content provider (MDCP);

FIG. 3 is a high-level block diagram showing a protocol implementation and example applications of the system;

FIG. 4 is a high-level block diagram showing an example implementation of the system whereby a third-party application utilizes the system under license;

FIG. 5 is a high-level block diagram showing an exemplary machine learning implementation of the system;

FIG. 6 is a schematic flow diagram showing communications in the system, between a server computer and a client interface;

FIG. 7 is an exemplary diagram showing an authentication process between the server computer and the client interface;

FIG. 8 is a high-level block diagram showing example commands transmitted from the server computer to the plurality of endpoint devices;

FIG. 9 is a diagram showing a breakdown of the time that a typical instruction would take using prior art methods and systems;

FIG. 10 is a diagram similar to FIG. 9, however showing a breakdown of the time that an instruction may take using the system and method of the present disclosure;

FIG. 11 is a high-level block diagram showing communication between the server computer and the client interface using Hypertext Transfer Protocol Secure (HTTPS) tunneling and cryptography;

FIG. 12 is a high-level block diagram showing details of an exemplary client interface provided on one of the endpoint devices;

FIG. 13 is a flow diagram showing an exemplary method of controlling a plurality of endpoint devices, both on-line and off-line, and showing state keeping features;

FIG. 14 is a flow diagram showing an example of how the system handles interruptions in connectivity between the server computer and the endpoint device;

FIG. 15 is a diagram showing an example of how the client interface interacts with the server computer;

FIG. 16 is a diagram showing incremental intervals that may be utilized by the client interface to attempt to reconnect to the server computer once the connection is lost;

FIG. 17 is a block diagram showing various exemplary components that may form part of the server computer;

FIG. 18 is a diagram showing an example of how the system handles jobs to be performed by endpoint devices, as well as events that are communicated back to the sever computer;

FIG. 19 is a diagram that shows how data may be transmitted in chunks from the client interface of the endpoint device to the server computer;

FIG. 20 is a high-level flow diagram illustrating an exemplary method of controlling a plurality of endpoint devices;

FIG. 21 illustrates an example of a computing device in which various aspects of the disclosure may be implemented;

FIG. 22 is a diagram showing a comparative view of prior art methods and systems to the present disclosure, illustrating the difference in connection latency for each initial connection;

FIG. 23 is a diagram showing a comparative view of prior art methods and systems to the present disclosure illustrating the difference in connection latency for each instruction once a persistent connection is established; and

FIG. 24 is a diagram showing a breakdown of the time that a typical instruction would take using the system and method of the present disclosure once a persistent connection has been established.

### DETAILED DESCRIPTION WITH REFERENCE TO THE DRAWINGS

In this specification, the terms “endpoint” and “endpoint device” or plural forms of these terms will be used to include any physical or virtual computing device or node in a digital communications network including, but not limited to, a server, a system, an ADC, or any other computing device.

There is provided a system and method for managing a plurality of endpoint devices distributed in a digital network. A central server may be provided at a backend, in communication with, or forming part of a cloud infrastructure. A plurality of servers may be utilized, for example in server clusters. These servers may be physical servers or virtual servers. A customer, which may be associated with the plurality of endpoint devices, may require control of the endpoint devices, or may require to send or receive data to and from the endpoint devices. The cloud infrastructure may be associated with the customer. The system may be configured such that data is pulled by each of the endpoint devices from the backend, whereafter the respective endpoint device may be authenticated and then a secure tunnel may be established between the backend and the endpoint device. Software may be resident on the endpoint device to facilitate this process and the software may be either hard coded, downloadable from the backend, or pre-installed to the endpoint device. When pulling data, the endpoint device may be configured to initiate the communications. Once authentication is performed, the secure tunnel may be kept open as a persistent secure connection. Control or command data may be transmitted via the tunnel for execution by a processor of the endpoint device, whereafter it may return a result or response to the backend. It should be appreciated that like features may be designated by like reference numerals in the Figures.

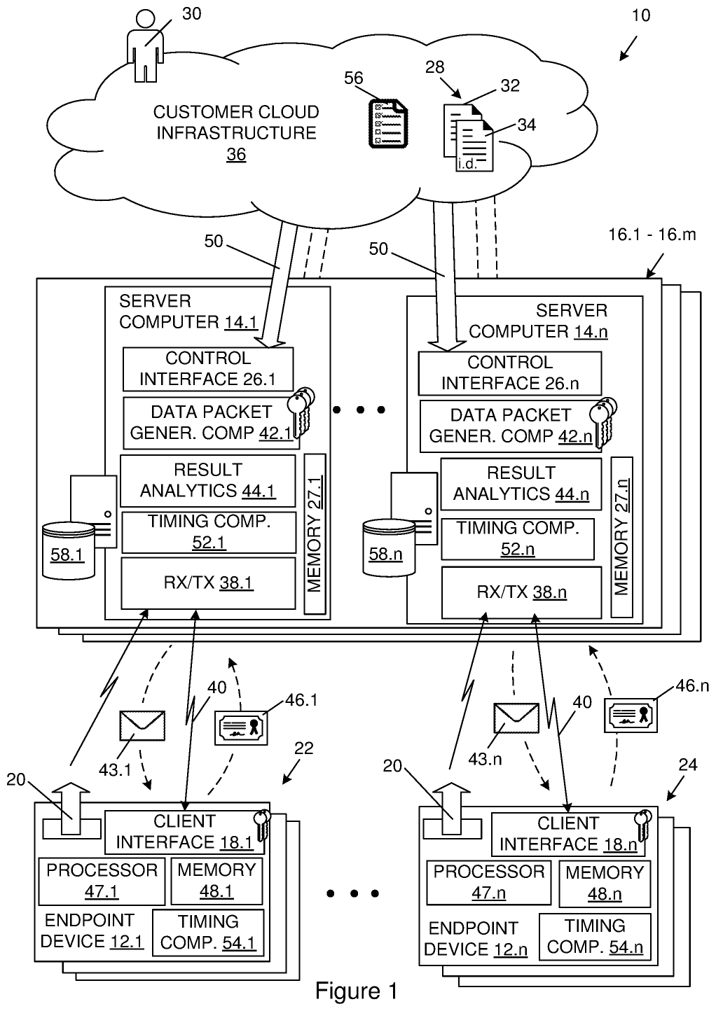

Referring to FIG. 1, there is provided a system (10) for controlling a plurality of endpoint devices (12.1 to 12.n). The system (10) may include at least one server computer, and may include a plurality of server computers (14.1 to 14.n) in data communication with the plurality of endpoint devices (12.1 to 12.n). Each server computer (14.1 to 14.n) may have a processor associated therewith. The servers (14.1 to 14.n) may be arranged in one or more server clusters (16.1 to 16.m), for example to provide server redundancy or to increase the number of endpoint devices that are able to be controlled. Each of the endpoint devices (12.1 to 12.n) may include a client interface (18.1 to 18.n). As is shown in FIG. 1, a first server computer (14.1) may be associated with a first group (22) having a number of endpoint devices (12), with an n^{th} server (14.n) being associated with a second group (24) having a number of endpoint devices (12). In one example embodiment, an endpoint device (12) may be a thin client device configured to initiate communications with a server. Also, by way of example, the endpoint device (12) does not require a central registry in order to connect with the server. The client interface may be referred to as a thin client as the client interface may be arranged to occupy a small amount of storage space (for example, less than 10 Megabytes in some embodiments described below). A control interface (26.1) of the server (also described in more detail below) may be referred to as a thin server, as it may also be arranged to occupy a small amount of storage space (for example, less than 10 Megabytes in some of the described embodiments). The thin client and thin server may facilitate efficient operation of the system (10) as the required computing power and computing time needed may be reduced, compared to known systems that the applicant is aware of, as will be described below. Examples of endpoint devices may include smart devices, such as, but not limited to: smart home appliances, smart vehicles, smart phones, tablets, laptop computers, security systems, Internet of Things (IoT) devices, or any type of computing device including a processor capable of executing the client interface (18.1) and communicating with the server computer (14.1).

The server computers (14.1 to 14.n) may form part of, or may be connected to a customer cloud infrastructure (36) which may include or be connected to a plurality of other server computers forming part of the system (10). The customer cloud infrastructure (36) may for example be associated with a customer (30) which may, in turn, be associated with one or more of the endpoint devices (12.1 to 12.n), however, other implementations are possible. Each server computer (14.1 to 14.n) may include the control interface (26.1 to 26.n) that may be configured to receive command data (28) to control one or more of the endpoint devices (12.1 to 12.n). The command data may be received from a customer (30) that wishes to control one or more of the endpoint devices (12.1 to 12.n). The command data (28) may for example include endpoint device instructions (32) and endpoint device identifiers (34). The server (14.1) may include a receiving component (38.1) for receiving multiple connection requests, each connection request originating from an endpoint device (12.1) identified by the received endpoint device identifiers (34).

The server computer (14.1) may be operable, responsive to receiving the connection request (20) of each endpoint device, to establish a persistent data communication session (40) between the server computer (14.1) and the client interface (18.1) of the endpoint device (12.1). In one example embodiment, a persistent data communication session may be a communication session that is initiated by a handshake process and continues until the connection is dropped. In some of the embodiments described, the endpoint device may automatically attempt to re-establish the connection after the connection is dropped or terminated. A secure HTTPS tunnel may be utilized in the persistent data communications session. A data packet generation component (42.1) may be provided at the server (14.1) for generating a data packet (43.1) which may include the command data (28) or part thereof. The data packet (43.1) destined for endpoint device (12.1) may include customer instructions or endpoint device instructions (32) for that particular endpoint device (12.1) and which may be specified by the customer (30).

At the server (14.1), a data packet transmitting component (38.1) may be operable to transmit the data packet (43.1) via the persistent data communication session (40) to the client interface (18.1) of each endpoint device identified by the endpoint device identifiers, to enable the endpoint device instructions (32) to be carried out by the endpoint device (12.1). The server (14.1) may further include a result analytics component (44.1) that may be operable to analyze result data (46.1) received by the receiving component (38.1) from the client interface (18.1) of the endpoint device (12.1), once the instructions are carried out. The instructions may be performed or carried out by a processor (47.1) associated with the endpoint device (12.1). In an example embodiment, the client interface (18.1) may be installed in a memory (48.1) or memory component of the endpoint device (12.1). It will be appreciated that other endpoint devices and other server computers of the system (10) may have similar components and features to endpoint device (12.1) and server computer (14.1).

The endpoint device instructions (32) may be configured to cause the processor (47.1) associated with the endpoint device (12.1) to carry out the endpoint device instructions (32). These endpoint device instructions may for example include any one or more of a read command, a write command and a run or execute command. Data, such as larger data files may also be transferred from the endpoint device (12.1) to the server computer (14.1) or vice versa during the persistent data communication session (40).

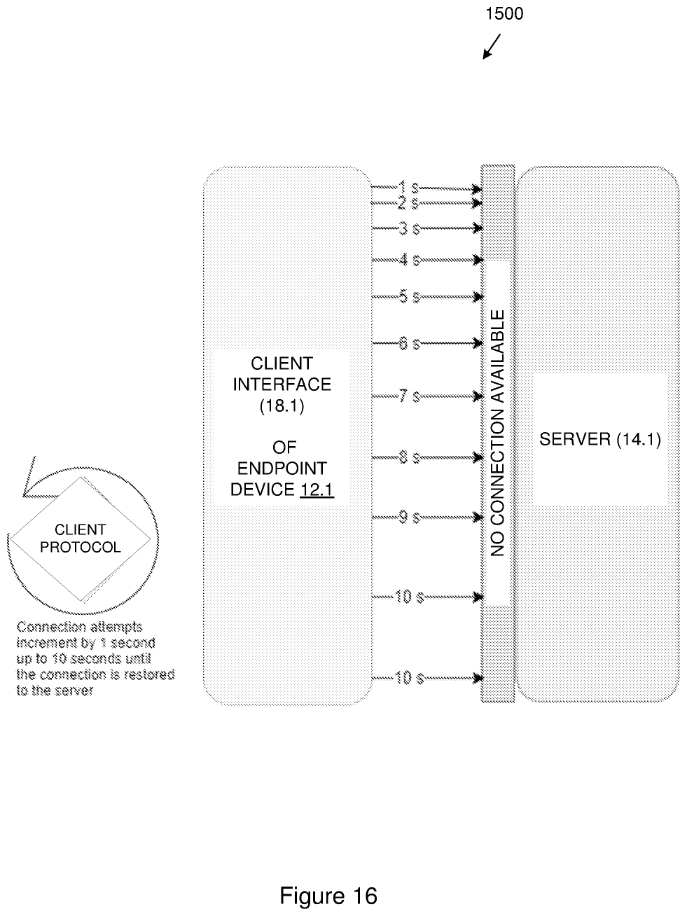

The client interface (18.1 to 18.n) of each endpoint device (12.1 to 12.n) may be configured, once the connection (40) between the client interface (18.1) and the server computer (14.1) is lost, to automatically transmit another outbound connection request (20) for the server computer (14.1) to reconnect or re-establish the persistent data communication session (40). The client interface (18.1) may further be configured to repetitively attempt to re-establish the persistent data communication session. These attempts may for example occur at intervals of once per second, or at increasing intervals of about 1, 2, 3, 4, 5, 6, 7, 8, 9, or up to 10 seconds, or at any other suitable interval, as will be described in more detail below with reference to FIG. 16.

The client interface (18.1) may be a standard client interface, and may be software that is downloaded and installed onto the endpoint device (12.1) from the server computer (14.1) during the persistent data communications session (40). Alternatively, the standard client interface (18.1) may be pre-installed onto the endpoint device during manufacture thereof. Updates such as client interface updates or firmware updates may also be transferred to the endpoint device (12.1) during the persistent data communications session, if needed. The client interface (18.1) may be hard coded in some embodiments. The client interface (18.1) may be dynamically updated during the persistent data communication session (40).

In the present embodiment of the system (10), the client interface (18.1) may be configured, if the data packet (43.1) is received and the persistent data communication session (40) is subsequently terminated for some reason, to nevertheless cause the endpoint device (12.1) to carry out the endpoint device instructions (32), and then to transmit the result data (46.1) once the persistent data communication session (40) is re-established again.

The customer cloud infrastructure may be in data communication with the control interface (26.1) of the server computer (14.1) using an application programming interface (API), for example using a representational state transfer (REST) API (50) and utilizing Hypertext Transfer Protocol Secure (HTTPS). However, other protocols may also be used.

The system (10) may provide the advantage that the persistent data communications session (40) need only be established once, and then a HTTPS tunnel (40) may be established. After the outbound request (20) is received by the receiving component (38.1) at the server (14.1), a handshake process may be performed between the server computer (14.1) and the client interface (18.1) of the endpoint device (12.1) to initiate the persistent data communication session (40). The persistent data communication session (40) may be a secure link which is established or negotiated, after which the server computer (14.1) may transmit the data packet (43.1) via the persistent data communication session (40) to the client interface (18.1) of the endpoint device (12.1). Hence, subsequent responses or result data (46.1) and data packets (43.1) may be sent and received via the secure HTTPS tunnel (40), without requiring the secure link to be re-negotiated. In other words, the handshake process need only be performed once. This is unlike conventional configurations where server computers connect to a plurality of endpoint devices in batch or sequential mode, where all of the connections are not held open in a persistent manner. Moreover, conventional server computers may require secure communications to be re-established or re-negotiated numerous times during a single communications session with an endpoint device, even if the connection is not interrupted, which may increase the required processing power and required processing time.

The data packet (43.1) may be time stamped by a timing component (52.1) at the server (14.1) and the result data (46.1) may, in turn, be time stamped by a timing component (54.1) of the endpoint device (12.1). The result data (46.1) may include an indication of whether the endpoint device instructions (32) were carried out successfully or not, or it may include error data if the endpoint device instructions (32) were not carried out successfully. Once the result data (46.1) is received at the server (14.1), it may be transmitted or relayed to the customer cloud infrastructure for further processing. The result data (46.1) may also be analyzed by the result analytics component (44.1) at the server (14.1).

When the endpoint device instructions (32) in the data packet (43.1) are received by the endpoint device (12.1), the instructions may cause the processor (47.1) to carry out the endpoint device instructions (32). These endpoint device instructions (32) may include any one or more of a read command, a write command and a run or execute command. Data, such as larger data files, may additionally be transferred from the endpoint device (12.1) to the server computer (14.1), or vice versa, during the persistent data communication session (40).

Still referring to FIG. 1, the control interface (26.1) of the server computer (14.1) may be configured to receive a list (56) of the endpoint device identifiers from the customer (30) for storage in a database (58.1) associated with the server computer (14.1). The server computer may, in turn, be configured to access the list in the database (58.1) to retrieve each endpoint device identifier, for example an identifier for each endpoint device (12.1, 12.2, 12.3 . . . ). The relevant endpoint device identifier may be included in the data packet (43.1) destined for that endpoint device (12.1) during the persistent data communication session (40). The server computer (14.1) may be arranged to utilize a look-up table, or the like, to retrieve the endpoint device identifier from the list (56).

When the data packet (43.1) is generated or packaged by the data packet generation component (42.1) of the server computer (14.1), the data packet may be encrypted at the server (14.1). Public and private key cryptography may be used to encrypt the data packet (43.1) (i.e. asymmetric cryptography) at the server (14.1). The client interface of the endpoint device (12.1) may, in turn, decrypt the data packet (43.1) when it is received via the persistent communication session (40). Public and private key cryptography may again be used on the client side, with the client interface (18.1) of the endpoint device (12.1) encrypting the result data (46.1) before it is transmitted back to the server (14.1). The server computer then decrypts the result data (46.1) when it is received from the client interface (18.1) of the endpoint device (12.1) during the persistent data communication session (40). In an exemplary embodiment of the present disclosure, the plurality of endpoint devices (12.1 to 12.n) may form part of an Internet of Things (IoT) network. However, different groups of endpoint devices (such as the first group (22) and the second group (24)) may form part of different digital networks controlled by the server computers (14.1 to 14.n) or server clusters (16.1 to 16.m). The communications of the persistent communication session (40), as well as the communications from the customer cloud infrastructure (36) to the servers (14.1 to 14.n) may be provided by a communications protocol. The communications protocol utilized during the persistent communications session (40) may be a unicast protocol.

In the present embodiment, the communications protocol may include a set of rules that governs communications between the server computers (14.1 to 14.n) and the client interface (18.1 to 18.n) of each endpoint device (12.1 to 12.n). The set of rules may be referred to as a contract, and may include, but need not be limited to, any one or more of the following rules:
that only endpoint device instructions (32) originating from the customer (30) are to be carried out by each endpoint device (12.1 to 12.n), or by a particular endpoint device (12.1), or by a group of endpoint devices (e.g. the first group (22));
that the data packet (43.1) can only be received from the server computer (14.1) during the persistent data communication session (40);
that only a data packet (43.1) received from the server computer (14.1) and including the endpoint device identifier (34) (e.g. a unique identification (ID) code of endpoint device (12.1)) is able to be utilized by that particular endpoint device (14.1);
that the endpoint device (12.1) or client interface (18.1) is only able to transmit the result data (46.1) to the server computer (14.1) if the received data packet (43.1) includes instructions originating from the server computer (14.1); and
that the endpoint device (12.1) is only able to transmit the result data (46.1) to the server computer (14.1) if the result data is a directly derivable result of the endpoint device instructions (32).

The communications between the customer cloud infrastructure (36) and the server computer (14.1), as well as between the server computer (14.1) and the client interface (18.1) of the endpoint device (12.1) may be provided by a secure communications link, for example by way of Hypertext Transfer Protocol Secure (HTTPS) utilizing Secure Sockets Layer (SSL) or Transport Layer Security (TLS), or any other cryptographic protocol, including asymmetric cryptography that utilizes public and private key pairs. In a present embodiment of the system (10), the communications may be provided by HTTP or HTTPS tunneling technology, however, embodiments may be possible that utilize User Datagram Protocol (UDP), or any other similar protocol.

To establish the persistent data communication session, the outbound connection request (20) is transmitted from the endpoint device (12.1). Then, the server receives (38.1) the request (20) and an authentication of the endpoint device may be performed. The server computer (14.1) may look up the endpoint device (12.1) in the list (56) (which may be stored in the database (58.1) received from the cloud (36)) and may authenticate the endpoint device (12.1) before establishing the persistent data communication session (40) with the client interface (18.1) of that endpoint device (12.1). The handshake process as described above may be performed.

In the present embodiment of the system (10), this handshake process may be performed in less than a second; alternatively, in less than 500 milliseconds (ms), and preferably in about 150 milliseconds This will also be discussed in more detail below. The persistent data communication session (40) may be a bi-directional session that enables communication between the server computer (14.1) and the client interface (18.1) of the endpoint device (12.1). The handshake and authentication process may open up the HTTPS tunnel (40) or persistent data communication session and thus enables the server computer (14.1) to transmit the data packet (43.1) very quickly and more efficiently than prior art methods or systems that the applicant is aware of. This may further enable controlling endpoint devices (12.1 to 12.n) at a much larger scale. The data packet (43.1) may be transmitted via the persistent data communication session (40) to the endpoint device within less than 100 milliseconds, and preferably within about 25 milliseconds or within about 5 milliseconds. Stated differently, a latency of the bi-directional persistent data communication session may be about 5 milliseconds, excluding a round trip time (RTT).

This low latency, coupled with the persistent data communication session (40) may enable the system (10) to control each endpoint device (12.1 to 12.n) in near-real time. The servers (14.1 to 14.n) and other clusters (16.1 to 16.m) may thus control each endpoint device (12.1 to 12.n) in near real-time. This may enable control applications that are not possible with currently available systems and methods. The system (10) may for example be configured to implement, with the server computer (14.1) or with the customer cloud infrastructure (36), a machine learning algorithm to react or to respond in near real-time to result data (46.1 to 46.n) received from one or more of the plurality of endpoint devices (12.1 to 12.n).

It will be appreciated that the server computer (14.1) may be a physical server or a virtual server. In the present embodiment, the client interface (18.1 to 18.n) of each endpoint device (12.1 to 12.n) may be standardized so that it may operate on various types of devices, and may be a thin client. The control interfaces (26.1 to 26.n) of the server computers (14.1 to 14.n) may, in turn, each be a thin server. The thin client (18.1) of endpoint device (12.1) may thus be configured to pull data from the thin server (14.1). The thin client may occupy less than 100 megabytes, alternatively less than 10 megabytes of storage space on a memory (48.1 to 48.n) associated with each endpoint device (12.1 to 12.n) which occupied storage space may exclude the memory required for the given instruction and contents of any packets or files within. The thin server may, in turn, occupy less than 100 megabytes, alternatively less than 10 megabytes of storage space on a memory (27.1 to 27.n) associated with each of the server computers (14.1 to 14.n) which occupied storage space may exclude the memory required for the given instruction and contents of any packets or files within. The server computers (14.1 to 14.n) may be endpoint-agnostic. The thin server may be software downloaded onto the server computers (14.1 to 14.n) from the customer cloud infrastructure (36). The thin client or client interface (18.1 to 18.n) of each endpoint device (12.1 to 12.n) may also be endpoint-agnostic.

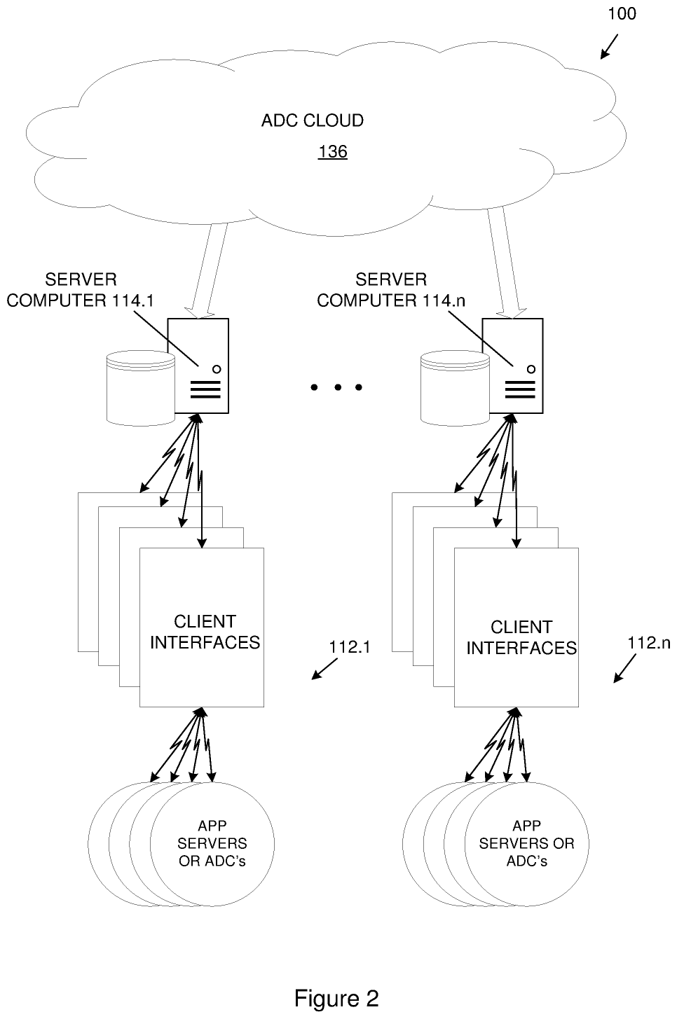

In FIG. 2 is shown a schematic high-level diagram showing an example implementation where a system (100) for controlling a plurality of endpoint devices (112.1 to 112.n) is provided for a major digital content provider (MDC). An Application Delivery Controller (ADC) cloud (136) is provided. The major digital content (MDC) provider may for example have a global set of a large number of ADCs, for example 10 000 ADCs may require control. The ability to communicate with all the ADCs through 1 or many servers (114.1 to 114.n) at very low-latency (near real-time), or as near as possible to simultaneously may be provided by the embodiments described herein.

Referring to FIGS. 1 and 2, the read, write and run commands (32) described above may be used. The read command may include reading data from the endpoint device (112.1). For example, reading data from configuration files, log files or obtaining live system information may be performed during the persistent data communication session (40). Moreover, network configuration settings may be validated. Data may be written to the endpoint device (112.1), and updating configurations for networking or the ADC may be performed. Execute commands on the endpoint device may be performed, such as restarting the endpoint device (112.1). Large files may also be transferred during the persistent data communications session (40). It may provide advantages to issue commands from the servers (114.1 to 114.n) to any or all of the clients (112.1 to 112.n), so that these commands may be issued and executed substantially in parallel and with as low latency as possible.

Every communication session (40) connection may be established securely, and a global standard library may be used. As described above, to comply with security best practices and to keep data secure, the communication session (40) may be SSL validated using SSL certificates over HTTPS. In the embodiment shown in FIG. 2, the endpoint devices (112.1 to 112.n) may be ADC's or App servers. In order to effectively manage the set of ADCs, it may be required to send and receive instructions between the servers (114.1 to 114.n) and the clients or client interfaces (112.1 to 112.n) in order to provide updates to configuration settings on the ADCs as well as sending data back from the clients (112.1 to 112.n) to the servers (114.1 to 114.n).

It may be necessary while transferring a large file from the ADC (112.1) to the server (114.1), mid-way through that file transfer during the communication session (40), to obtain statistics of a processor and memory (not shown in FIG. 2) associated with the relevant ADC (112.1). In the present embodiment, the system (100) may have the ability to establish multiple simultaneous connections between the server (114.1) and the ADC (112.1) for optimized communications (or as near as possible to simultaneous). Features of the present disclosure may provide a single protocol for communications, not a combined set of protocols.

Implementing this protocol with an MDC with as low as possible latency may facilitate effectively scaling the number of ADCs (112.1 to 112.n) able to be controlled by the system (100). Outbound connection requests may thus originate from the ADC servers (i.e. from the endpoint devices (112.1 to 112.n)). The ADCs (112.1 to 112.n) may be located in a so-called demilitarized zone (DMZ) or subnetwork which may be locked down. The protocol or system (100) may therefore enable outbound connection requests. Outbound connections from the ADC servers (112.1 to 112.n) may be advantageous as it lowers the complexity of the networking and security infrastructure, and may for example remove the requirement for firewall updates. The outbound connection request may provide the benefit that the ADC server does not need to maintain a list of connections where a client may possibly exist, but only the client's current connection details.

If an interruption in the network or connectivity occurs between the ADC (112.1) and the server (114.1), the ADC (112.1) may continue and attempt to re-establish connection to the server (114.1). Once the data communication session is re-established, the instructions or work that commenced during the down-time may be sent back to the server (114.1). Hence, the endpoint devices or ADCs (112.1 to 112.n) may continue to function if there is a break in the connection between the server (114.1) and the ADC (112.1). Additionally, any instruction that was successfully received by the ADC that does not require a connection with the Server, may be executed, the result may be stored at the ADC or endpoint device (112.1), and the result may then be returned back to the server (114.1) once the connection or data communication session has been re-established.

There is hence provided the ability to schedule instructions on both the server (114.1) and the ADC (112.1) supported by a storage system to store results. Automation may thus be provided with the systems and methods described herein. Scheduling of instructions on both the server (114.1) and the client or endpoint device (112.1) may thus be performed. A scheduling system may also be supported with a local storage engine, so that in the event of a disconnect between the server (114.1) and the client (112.2), the schedule and/or instructions may be continued offline.

A RESTful API may be used providing feature parity which may enable integration with components of the system (100). A number of endpoint devices, for example ranging from 10's to millions may be controlled with the system (100) as it enables fast (near instant) outbound communication as well as near real-time control. Server/Management layer systems may require the ability to communicate to all the controlled or managed endpoint devices simultaneously, or near simultaneously (or ad-hoc). Changes or updates may additionally be pushed from the server to the endpoint devices which may cause them to read update data.

The system (100) may further plug into services such as Envoy™, Istio™, HAProxy™, Nginx™, and others, and may provide an application delivery mesh, managed or controlled from a centralized location, server (114.1) or cloud (136). The system (100) may be complementary to open source systems and may thus provide customizability, scriptability and tooling. The system (100) may be utilized with Linux™. The system (100) may also be retro-fitted or installed onto existing open source load balancers.

Still referring to FIG. 2, the system (100) may provide upwards communication to an integration system such as a cloud interface (136) or API aggregated management tool, while communicating downwards with all the attached clients (112.1 to 112.n). The plurality of servers (114.1 to 114.n) may be used in parallel, or substantially in parallel, and may provide the following features:
A single server (114.1) may connect to Multiple Clients (112.1) (or a group of clients or endpoint devices (112.1));
A single client (112.1) or endpoint device may connect to a single server (114.1);
Many servers (114.1 to 114.n) may be used in parallel in a server pool or server cluster, and may manage or control different clients (112.1 to 112.n);
In the event that one of the servers (114.1 to 114.n) is down (e.g. its power is interrupted), a client (112.1) may connect to another server (114.2 to 114.n) in the server pool. The relevant server (114.2 to 114.n) taking over may then source the required connection details from a shared resource (e.g. from the cloud (136)) that may only be available to servers forming part of the system (100).

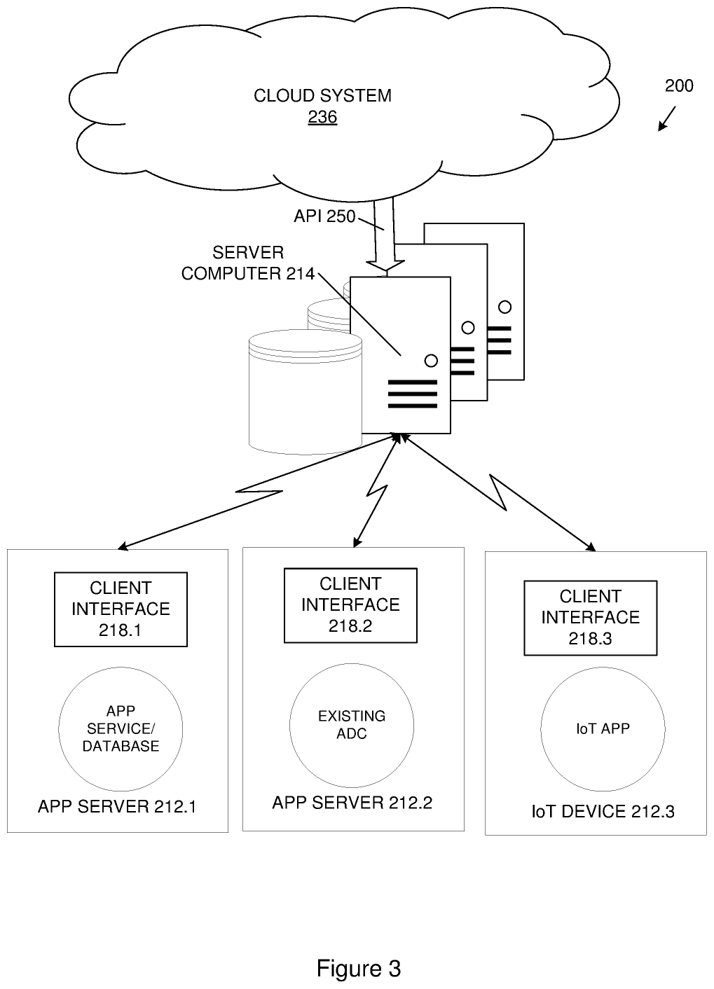

FIG. 3 shows a further implementation of a protocol implementation of a system (200) including a centralized server (214) for controlling endpoint devices (212.1, 212.2, 212.3) with client interfaces (218.1, 218.2, 218.3). For an exemplary MDCP use case, a cloud system (236) may manage multiple servers globally through the use of the server API (250). Instructions, also referred to as jobs, may be issued through the Server (214) to the various client interfaces (218.1 to 218.3) which may execute the instructions. An output or result of the instruction may then be communicated back from the client (218.1 to 218.3) to the Server (214) and finally back to the cloud system (236). Management or control may be performed via the API (250) as a user interface need not be required. An API integration tool for executing instructions may be used.

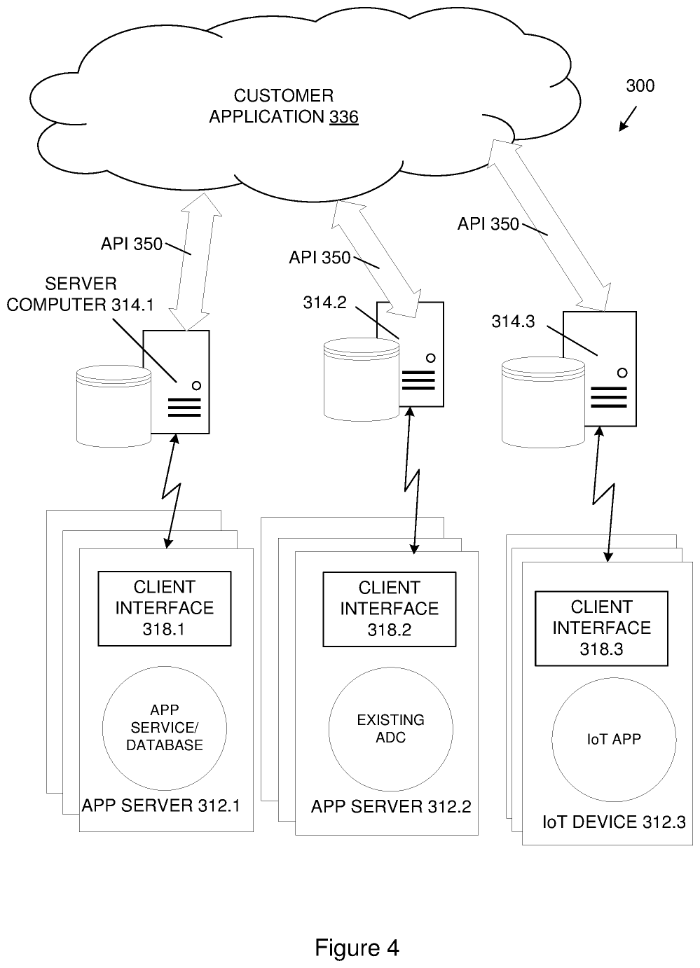

FIG. 4 shows an exemplary implementation wherein a system (300) may be provided as a licensed protocol for example in a customer datacenter implementation. A customer application may operate over the cloud (336). Further features may be similar to those described above for example in FIG. 3. As illustrated in FIG. 4, a third party or customer application (336) may utilize embodiments described herein under licence. The licensed system (300) may provide a customer management application which may integrate with the servers (314.1 to 314.3) via the API (350), wherein each server may be operable to control or manage multiple sets of clients or client interfaces (318.1 to 318.3). The system may be utilized over a variety of devices, operating systems and a development language such as Go™ may be used. Websockets may furthermore be used for communications. Exemplary use cases of endpoint devices (312.1 to 312.3) may include application (App) services, databases, existing ADC's and IoT Apps.

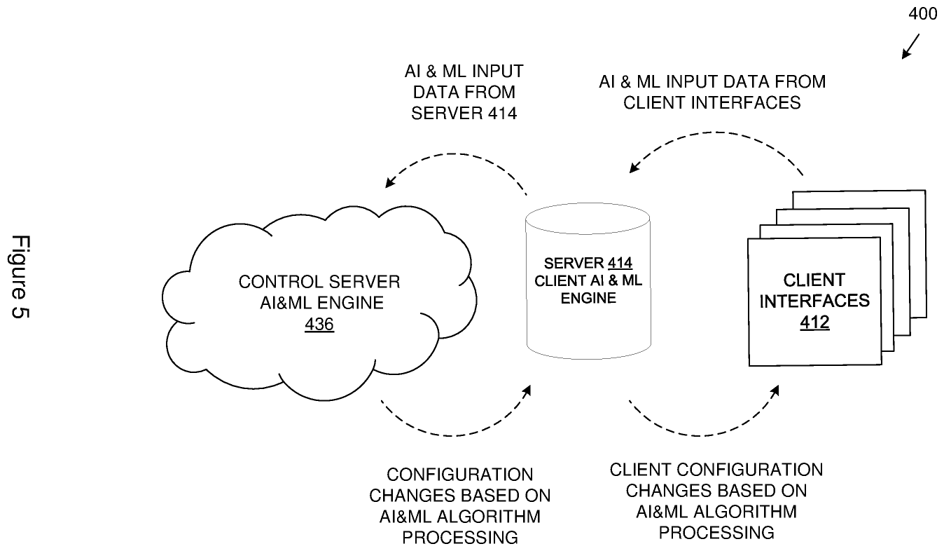

FIG. 5 shows an exemplary system (400) of controlling a plurality of endpoint devices having client interfaces (412). Artificial Intelligence (AI) and/or Machine Learning (ML) input data may be received at the server (414), which may be a server similar to the server computer described above, however it may include a client AI and/or ML engine. AI and/or ML data from the server (414) may be sent to the cloud, or to a control server (436). The control server may also include an AI and/or ML engine thereat. Configuration changes based on AI and/or ML algorithm processing may then be transmitted back to the server (414), and client configuration changes based on the AI and/or ML algorithm processing may then be transmitted to the various clients. This may be performed via the persistent data communication session(s) as described above.

The system (400) may for example be used in ADC applications. AI and/or ML require relatively large data sets or large amounts of data to learn from. AI and/or ML algorithms may utilize learning models. The protocol or system (400) may provide near-real time data from the client interfaces (412). The data from the client interfaces may be user-defined parameters from the clients (412) to the server (414). Data may hence be provided to the AI learning algorithm, and software logic may be adjusted according to simulations. Configuration settings may be optimized or enhanced and these optimized or enhanced settings may then be pushed back to the clients (412). The control server or cloud (436) may include a learning engine using AI and/or ML coupled with reactionary workflows. The one or more clients (412) may send data required by the learning models to the server (414), where it may be processed and may then trigger configuration changes to either scale up or down ADC settings depending on the AI configuration. As mentioned above, in exemplary embodiments, there may be a plurality of servers similar to the server (414) for example arranged in server clusters, and the control server (436) may poll the server (414) for data required for the scaling of servers and apply that data to the learning models. The control server (436) may deploy or reconfigure servers (414) depending on the output from these AI and/or ML algorithms.

It will be appreciated that embodiments described herein may enable millions of endpoint devices to send data to a centralized location as well as receive instruction sets, in an IoT implementation. This may happen substantially at the same time, and in near-real time. The client interface may be a thin client and may be “lightweight”. Hence, the client interface may be bundled in any IoT device to enable it to be controlled from a centralized location, enabling scaling and providing robustness even with limited or intermittent connectivity. Features of embodiments of the systems described are that the system may enable endpoint devices to automatically come online and “discover” a method to connect to the server. The server's large-scale design and usage of the communication protocol described may enable client interface to manage a near infinite number of IoT devices in parallel and send or receive high volumes of simultaneous communications from those devices. The ability of client interfaces or endpoint devices to come online automatically and self-discover a connection to the server, combined with the near infinite scalability (in terms of device numbers or simultaneous communications) may provide advantages over prior art systems and methods that the applicant is aware of. In addition, reliability, flexibility and ease of use may be provided by the systems and methods described, particularly in IoT devices and applications. This may be enabled as inbound access or inbound communications from the server to the client interfaces may not be required. This may enable the system to be utilized over a variety of digital networks, and may provide robustness or fault tolerance. This may also facilitate reading sensor data and sending IoT control instructions with ease and may provide greater efficiency compared to existing technologies.

Implementations that utilize Linux™ or Windows™ may be possible. Spinning up cloud-native and modern environments at scale may be facilitated. Vendors may have thousands to millions of individual Linux™ (and other) devices forming part of cloud-native deployments, clouds, supercomputers and more. The embodiments described herein may provide control of these devices substantially in parallel and may not requiring a direct or inbound connection to the devices, which may solve or at least alleviate some of the problems mentioned in the background of this specification. Example applications may be orchestration companies, from open-source container orchestration systems for automating application deployment, scaling and management such as Kubernetes or Chef. Other implementations may be large vendors of equipment, and cloud service providers.

The embodiments described may provide a lightweight and efficient connection from the servers to the client interfaces, and may provide a medium for log streaming, to stream log entries out of an application server or IoT device. Obtaining application exceptions or overload messages from an application may typically be written to a log file which can be streamed directly from the client interface or client of the endpoint device to the server, and notification and escalation via Simple Network Management Protocol (SNMP), Simple Mail Transfer Protocol (SMTP), short message service (SMS), or other methods may be provided to either the customer cloud interface or via the API.

Referring again to FIG. 1, the customer (30) may for example be a device manufacturer such as Samsung™, Apple™, Tesla™, BMW™, Bosch™, and many more. These device manufacturers may provide “smart devices” or endpoint devices (12.1 to 12.n) from cars to televisions that work in unpredictable networks and need to receive updates, control information, and submit information back to the vendor or customer (30). The system (10) and protocol described above may enable control of these smart devices in a lightweight and scalable environment, while it may be tolerant of disconnection periods, e.g. the client interfaces (18.1 to 18.n) may continue to read, write or run commands (28) should the connection to the respective server (14.1 to 14.n) fail or be interrupted. The client interface described herein may provide the ability to operate on a variety of computing devices, from cellphones to embedded systems, fridges to cars, and once the client interface manages to obtain an internet connection, it may receive a new set of instructions (32) and may request required information or data from the respective server (14.1 to 14.n). This may provide near-real time control at a global scale.

The near real time communication and near-zero latency may facilitate communicating with endpoint devices, and may provide a non-linear load—e.g. the more endpoint devices or nodes that are connected do not necessarily result in a slowdown of communication or an increase in latency may be alleviated or avoided. For example, the client (30) such as Samsung™ may be enabled to determine how many smart televisions are turned on at once, or to deploy a message to millions (or a near infinite number) of consumers at the same time. The described embodiments may enable monitoring or control of the running processes, memory, and file signatures of the plurality of endpoint devices within a network, cluster, cloud, organization, etc. An ability may be provided to, at near-zero latency, detect an anomaly in the traffic or file signature on an endpoint device (which endpoint device may be a system or sub-system). This may facilitate security, for example, once an intruder modifies a file, or logs in to a system or endpoint device, this act may be detected in near-real time in a matter of seconds or milliseconds or even nanoseconds. The relevant customer (30) or administrator may then be notified or alerted.

Referring again to the exemplary implementation in FIG. 5, further features may provide for the AI to learn which behavior or data of the system (400) is considered normal, and accordingly the AI engine may adjust what it believes or determines to be a threat. This knowledge or information may be shared from and to the various nodes or endpoint devices. In this way, it may be possible to rapidly pick up new and unknown “0-day” threats that may provide advantages over prior art systems and methods that the applicant is aware of.

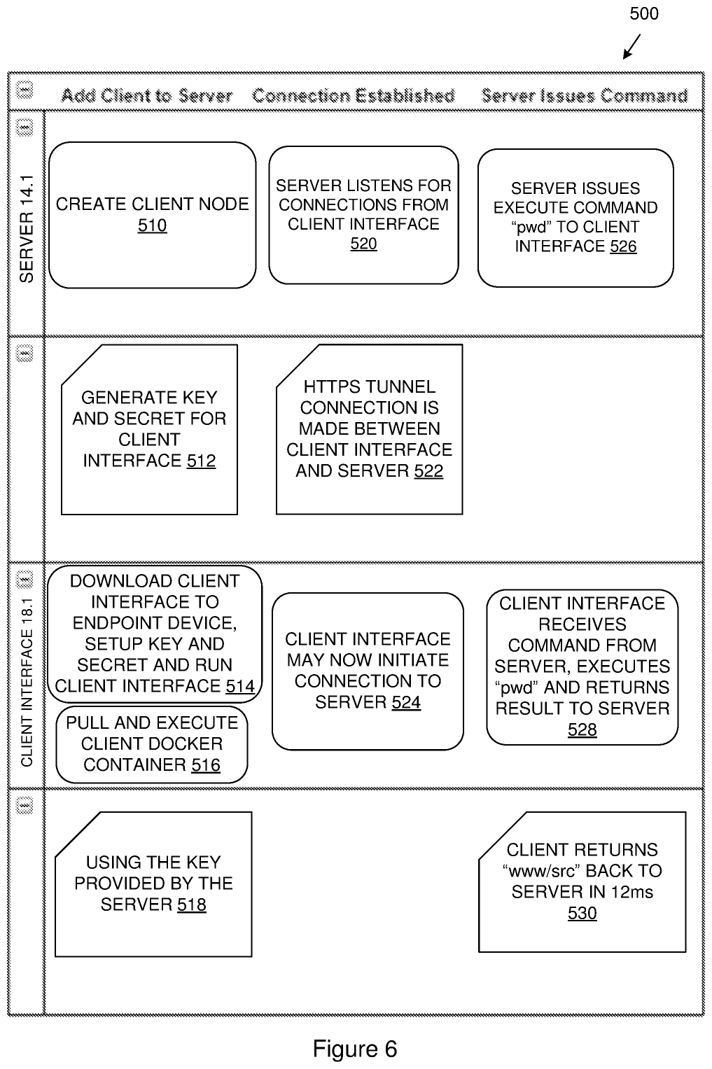

Referring now to FIG. 6, there is shown a schematic flow diagram (500) showing communications in the system, in an example of communications between the server computer(s) (14.1 to 14.n) and each client interface (18.1 to 18.n) of FIG. 1. As described above, there is provided a protocol for communication between the client or client interfaces (18.1 to 18.n) and the one or more servers (14.1 to 14.n). An API may be available for each of the server (14.1), the client interface (18.1) and the overall protocol. The protocol may be binary safe, and may allow near-instant communication with low latency, at a massive or hyper scale. The protocol or system (10) may be capable of sending multiple communications, reading and writing multiple binary data and files (containing any type of information), and may execute a large number of commands substantially simultaneously and/or substantially in parallel. Communications via the protocol, i.e. between the client interfaces and the server(s), as well as between the server and the customer cloud infrastructure may also be encrypted.

To add a client or endpoint device to the server: A client node or endpoint device may be created (510). The server (14.1) may generate (512) a key pair (e.g. a public key and a secret or private key) for the client interface. The client interface may be downloaded (514) to the endpoint device, the key and secret key may be set up, and the client interface may be run by the processor (47.1). The endpoint device and/or client interface (12.1, 18.1) may then pull (516) and execute a client docker container from the server (14.1). The key provided by the server may be used (518). Once the connection is established: the server may listen (520) for connections from client interfaces. A HTTPS tunnel connection may be established (522). The client interface (18.1) may now be enabled to initiate (524) connections to the server (14.1) by initiating the request (20) for communications. The server (14.1) may then issue (526) commands or command data (28) (an example command of “pwd” may be sent) to the client interface (18.1). The command may be received (528) by the endpoint device, and executed, and the result may be returned to the server. The client interface (18.1) may return the result data (46.1) (for example including a result “www/src”) back to the server in about 12 milliseconds.

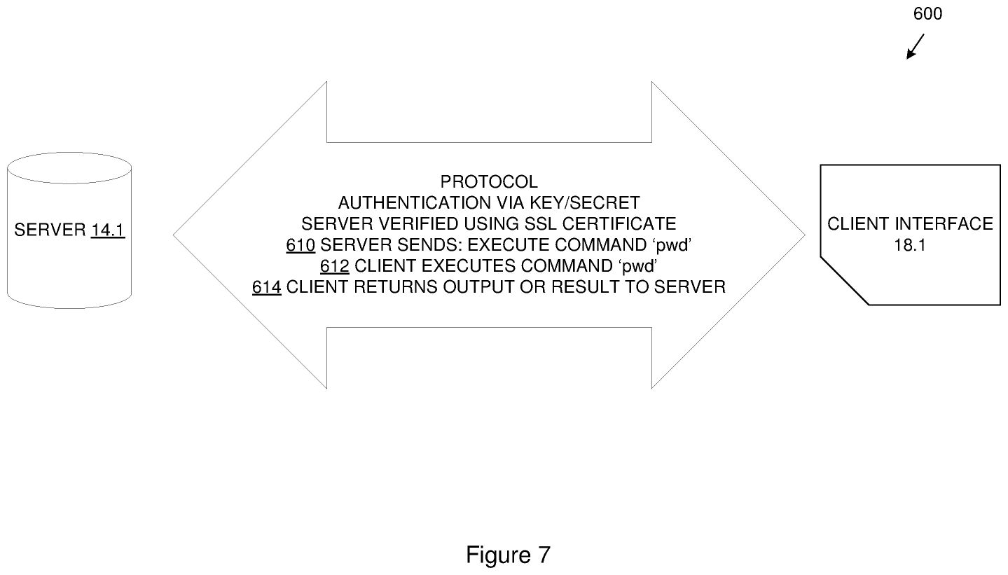

Referring now to FIG. 7, there is shown an exemplary diagram (600) showing an authentication process between the server computer (14.1) and the client interface (18.1). The protocol or system may utilize authentication via a cryptographic key pair or key and secret, and the server verified using an SSL certificate. The server may send (610) the execute command ‘pwd’ to the client interface or client. The client or endpoint device (12.1) may execute (612) the command ‘pwd’. The client may then return (614) the output or result to server (14.1).

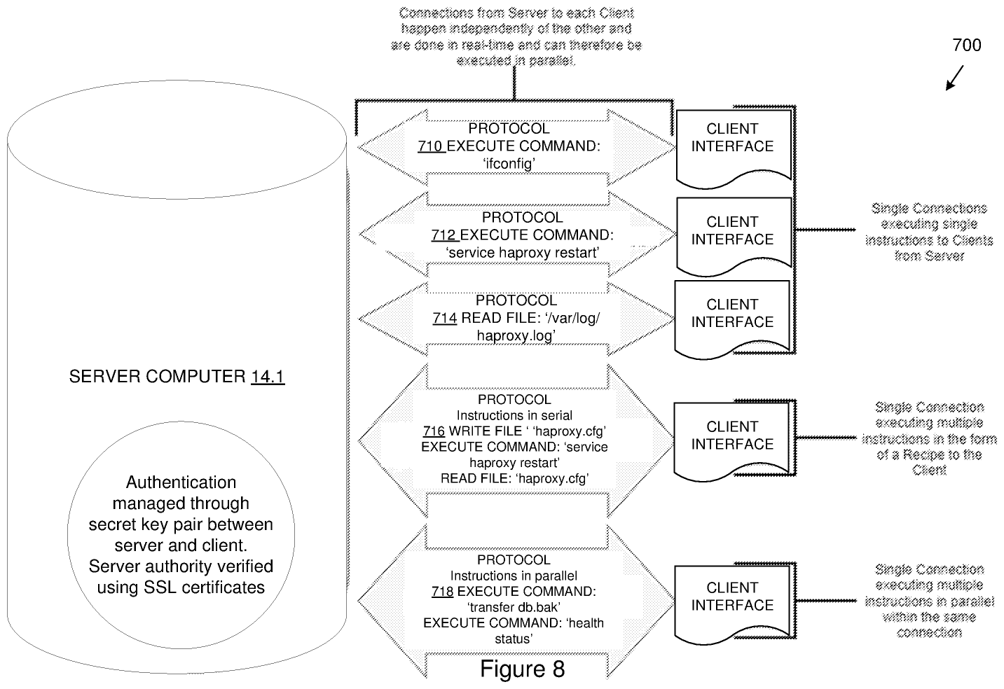

In FIG. 8 is shown a high-level block diagram (700) showing example commands transmitted from the server computer to the plurality of endpoint devices. Multiple connections may be established and multiple commands may be issued, when the server and client interface are already authenticated using a key pair. FIG. 8 Illustrates examples of types of communications with commands that may be used in the MDCP use case. At (710), a network interface configuration for an ADC may be obtained. A single command may be issued by the server to the client interface to ascertain once a connection is made, what the network configuration of the Linux™-based application server may be, by issuing ‘ifconfig’. ‘ifconfig’ may return the network interface configuration for that system or endpoint device, containing information such as IP address, Gateway information, DNS Server information and the state of the interfaces. This may be relevant to MDCP as networking may be an important element of load balancing traffic for media content, and knowing exactly what the network configurations are for each of the ADCs may facilitate optimal running of services.

At (712), an ADC service may be restarted. A command may be issued by the server (14.1) to the client (18.1) to restart a ‘HAProxy service’ on an ADC (when the endpoint device (12.1) is an ADC server). Services (daemons) on ADC servers may often require a restart for various reasons which the server (14.1) may issue to the client (12.1) for execution. In this case, ‘HAProxy’ may be a load balancing application on the ADC which forwards the specific type of network traffic as per a set configuration. If that configuration is updated, a service restart of ‘HAProxy’ may be required, before the change may be applied correctly.

At (714), reading an application log file may be performed. When issues from the endpoint device are reported, log files may be a first port of call when troubleshooting an issue. It may be important that log files can be read over the protocol to enable support technicians to solve issues customers report. In the example provided, a customer of MDCP has encountered an issue with HAProxy failing to start up on a particular ADC. An MDCP support technician may read the /var/log/haproxy.log file through the server to understand what is the issue.

Executing a set of instructions may be performed in serial (716). A set of instructions may need to be executed in serial as there is a dependency on one instruction to have completed before another is executed, but a group of instructions can be pre-configured to be executed for the sequence to have value. In the exemplary case for MDCP, it may be required to update a specific configuration in HAProxy which requires a service restart as well as to read the configuration file back to ensure that the configuration is correctly updated. The server (14.1) may send through a set of three jobs, dependant on each other (a job chain):
(i) WRITE/etc/haproxy/haproxy.cfg—this may replace the haproxy.cfg on the client system with that given by the server.
(ii) Once the configuration file has been updated, the next instruction may be to restart the HAProxy service to activate the configuration changes, using EXECUTE service haproxy restart.
(iii) To validate the configuration has been retained the haproxy.cfg file may be read back to the server (14.1) for analysis and validation using READ haproxy.cfg.

Executing instructions in parallel or substantially in parallel may be performed (718). Often there may be long running instructions sent by the server (14.1) to the client interface (18.1). The system may prevent or alleviate these long running instructions from hampering any other communication between the server (14.1) and the client or endpoint device (12.1). Parallel execution of instructions may allow for this by, using splicing to enable multiple threads of instruction execution. A large file, such as a backup, as per a standard backup solution, would be transferred from the client to the server which, depending on the connection speed, could take up to an hour. During this period, it is critical that all service, system and throughput metrics continue to be reported back to the Server. Using splicing the reporting instruction may be processed whilst the file transfer is in progress.

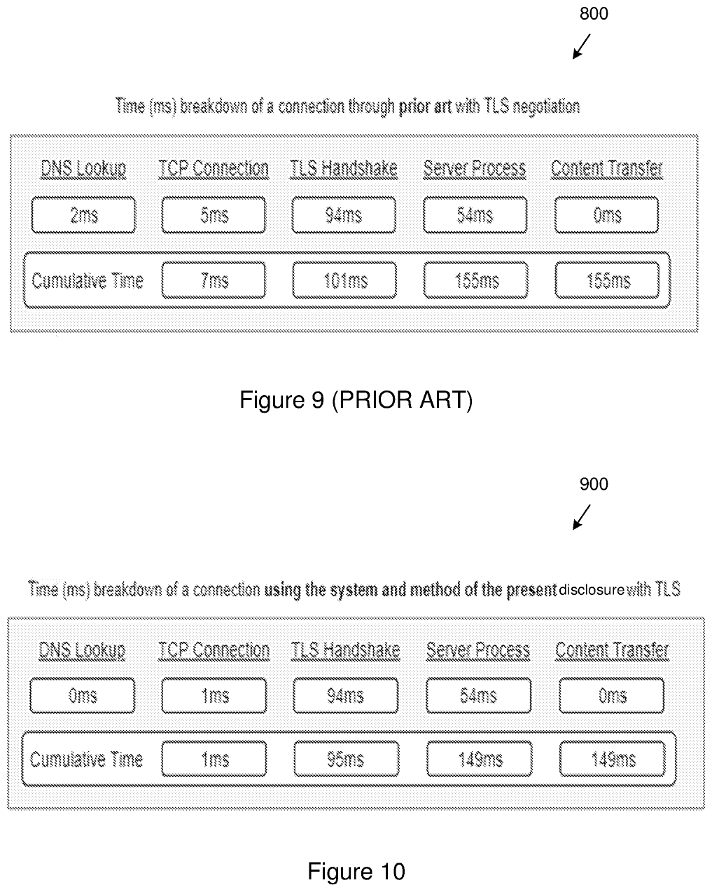

FIG. 9 shows a diagram (800) showing a breakdown of the time that a typical instruction would take using prior art methods and systems for an initial connection between two systems, for example between a server and an endpoint device. FIG. 10 shows a diagram (900) similar to FIG. 9, however it shows a breakdown of the time that an instruction may take using the system and method of the present disclosure for the initial connection between the server (14.1) and the client interface (18.1).

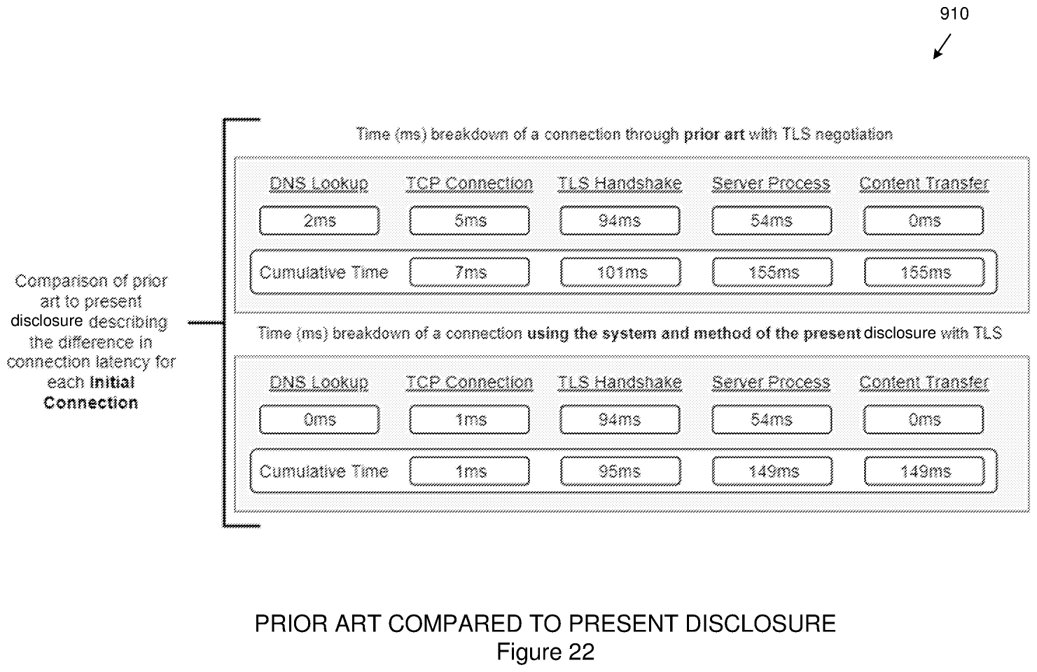

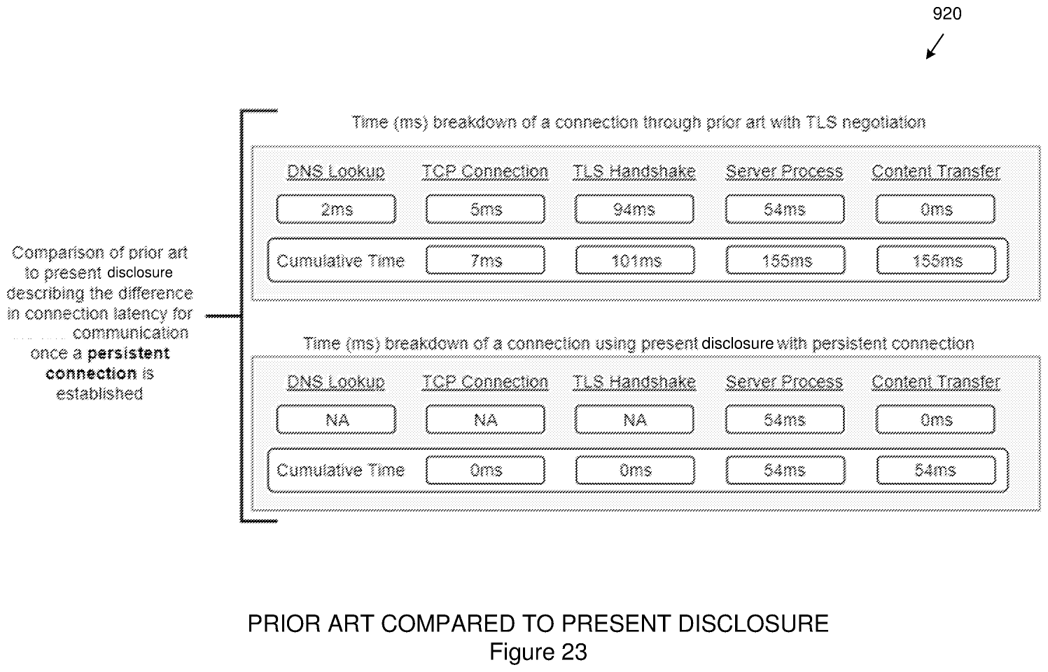

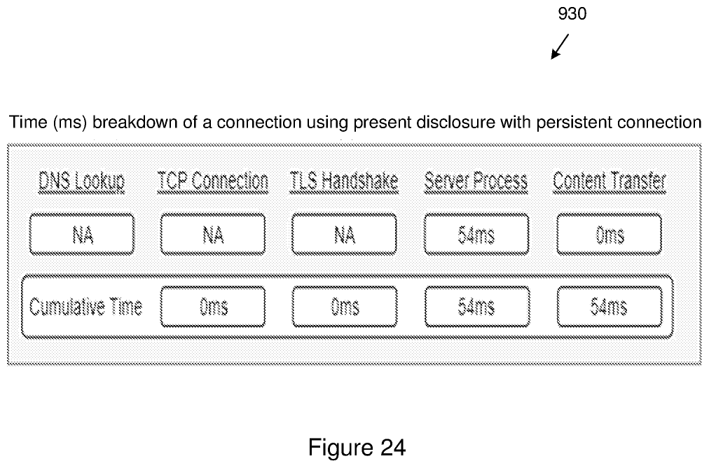

FIG. 22 is a diagram (910) which illustrates a comparative view of prior art methods and systems as compared to the present disclosure; showing the difference in connection latency for each initial connection. FIG. 23 is a diagram (920) illustrating a comparative view of prior art methods and systems as compared to the present disclosure and shows the difference in connection latency for each instruction once a persistent connection is established. FIG. 24 is a diagram (930) showing a breakdown of the time that a typical instruction would take using the system and method of the present disclosure once a persistent connection has been established.

Description Detailing Reasons for Low Latency Coupled with Scale and Parallelism

As mentioned in the background of this specification, previous methods of managing connections may include elements of the connection process that may not be essential when making use of HTTP tunneling technology.

Instantiating a connection:
The systems and methods may require that each instruction sent may first require a connection to be established. Couple this method with a secure component such as Transport Layer Security (TLS), it becomes clear that most of the time taken to complete the instruction is by setting up the connection securely, rather than processing the instruction.

Long-polling
This method of managing a connection is where a placeholder connection may be opened in anticipation of an instruction. This loses efficacy in the scenario where many instructions are being sent over a connection because the connection is still instantiated per instruction.

An example of a standard, prior art connection instantiation is shown in FIG. 9, utilizing TLS with instruction processing.

By comparison, a connection with instruction processing according to embodiments described herein is shown in FIG. 24. The protocol and system described herein may make use of HTTP tunnel technology. This may allow for the connection to be established once, and security to be negotiated and agreed once, and not on a per instruction basis. The benefit of this is illustrated by comparing the total times in FIGS. 9 and 24. With the prior art shown in FIG. 9, the total time is about 155 milliseconds (ms), whereas with the present embodiments of the disclosure the total time may be as little as about 54 ms as is indicated in FIG. 24.

In FIG. 10, for an initial connection using the present disclosure, a Domain Name System (DNS) lookup and name lookup may be made in about Oms or near-instantly. A Transmission Control Protocol (TCP) connection may be made in about 1 ms, a TLS handshake may take about 94 ms. Server processing may take about 54 ms and content transfer may be performed in about Oms or near-instantly. The total cumulative time may thus be about 149 ms. Once the initial connection is made, the persistent data communication session may be kept open.

As shown in FIG. 24, for the present disclosure, a Domain Name System (DNS) lookup, name lookup, TCP connection and TLS handshake may not need to be performed, once the persistent data communication session is established. Server processing may take about 54 ms and content transfer may take about Oms (in other words, less than 0.5 ms, or near-instantly). The total time taken to complete processing and transfer may thus be about 54 ms. It will be appreciated that FIGS. 9, 10 and 22 to 24 are examples, and actual time periods may vary. However, it will further be appreciated that the systems and methods described herein may be significantly faster than the prior art. It may be computationally expensive to begin communicating with security, but is may be very cheap or efficient to continue communicating with security once it has been established (i.e. once the persistent data communications session (40) is established for example with HTTPS tunneling).

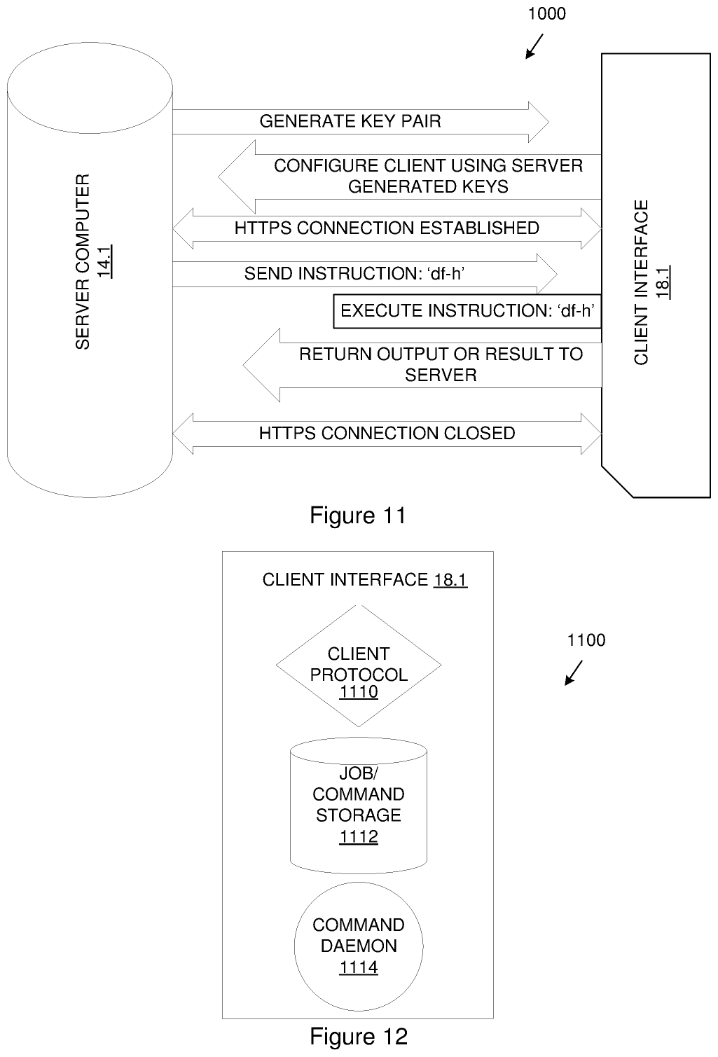

In FIG. 11 is shown a high-level block diagram (1000) showing communication between the server computer (14.1) and the client interface (18.1) using Hypertext Transfer Protocol Secure (HTTPS) tunneling and cryptography. Authentication may be configured through a secret key pair that may be generated when the client or endpoint device (12.1) is created or registered on the server (14.1). The key may then be applied to the connection on the client interface (18.1) to pair the server (14.1) and client interface (18.1). The pairing may be utilized to create the persistent data communication session (40) and may be maintained for all future connections between the particular endpoint device (12.1) and the server (14.1).

FIG. 12 illustrates a high-level block diagram (1100) showing details of an exemplary client interface (18.1) that may be provided on endpoint device (12.1). A local state store may be provided at the client interface (18.1) The protocol (1110) may be a communication method used between the client interface (18.1) and the server (14.1). An API may be available for all primary functionality for the server, client and protocol. The protocol may be binary safe. It may be capable of sending multiple communications, reading and writing multiple binaries and files (containing any type of information), as well as executing almost any number of commands, in each case, substantially simultaneously and in parallel. Communications via the Protocol may be encrypted. The client interface may be able to control a host application server. The connection may be made outbound via an HTTPS connection from the client (18.1) to the server (14.1), meaning the server does not need inbound access to function with it. It can continue to run even where the connection to the server (14.1) fails, and the HTTPS connection means that it may be able to function in any networked environment.

The client interface or client (18.1) may be split into 3 main components:

1. A Job Storage Database (1112):
All jobs that are scheduled or requested by the Server may be stored in a state within the Job Storage Database (1112);
If a connection is lost between Client and Server, the state and relevant information may be stored and once the connection is restored, the response may be sent;

2. A Command Daemon (1114) or computer process:
This daemon may listen and execute commands (28) received by the server (14.1) and may be responsible for returning the responses back to the server;
The daemon may further be used for scheduling;

3. Client Protocol Implementation (1110)
Management of connections to the Server (14.1) may be performed;
The client (18.1) may connect out-bound to the Server (14.1)
Multiple commands may be executed within the same connection tunnel (40)
If the client (18.1) is not connected to the Server it may continuously try to re-establish the connection.

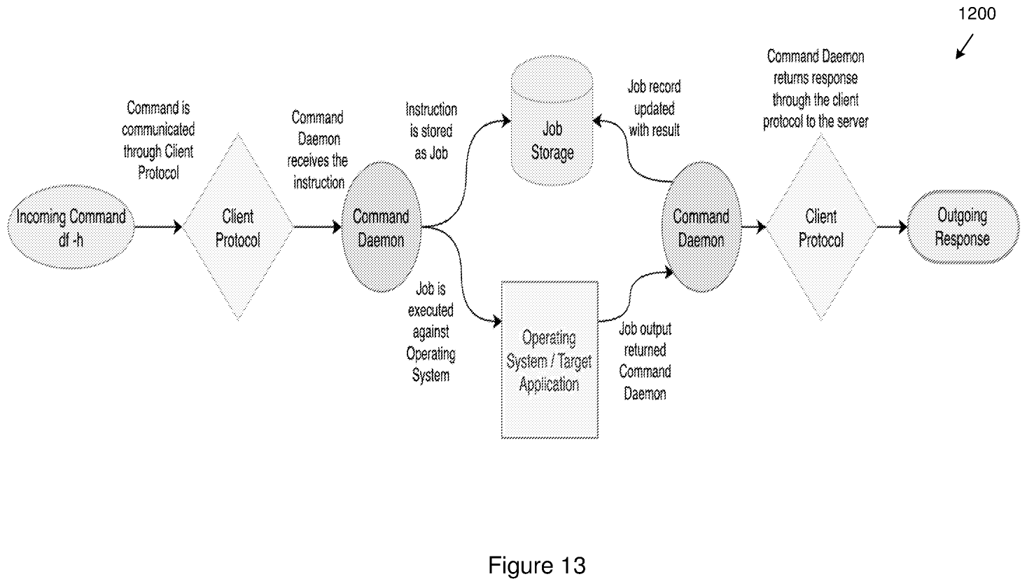

FIG. 13 shows an example flow diagram (1200) of an exemplary method of controlling a plurality of endpoint devices, both on-line and off-line, and showing state keeping features.

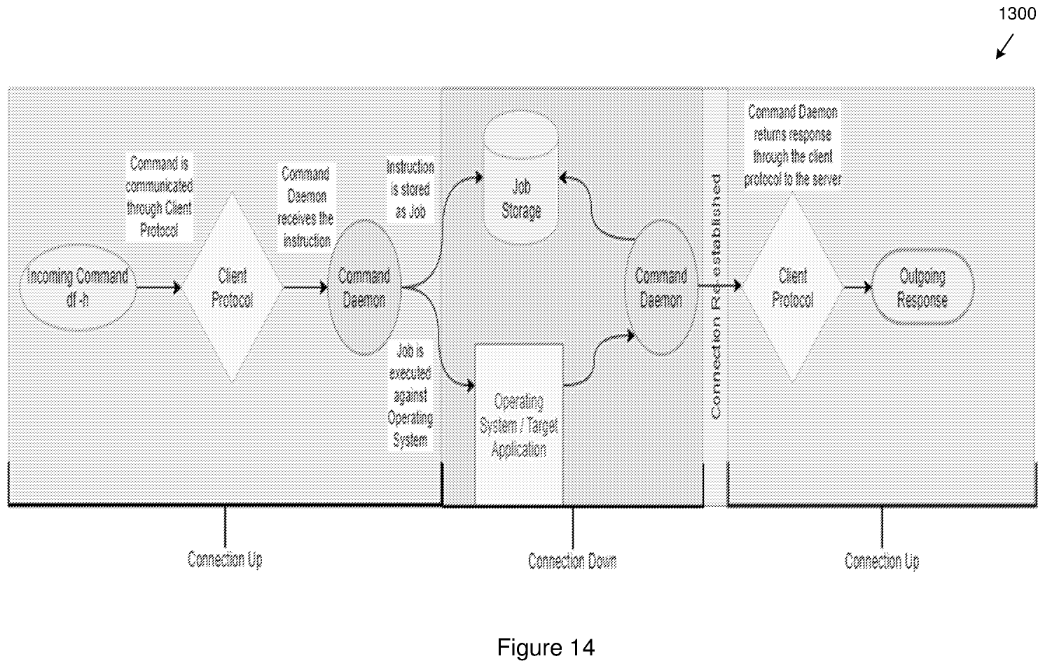

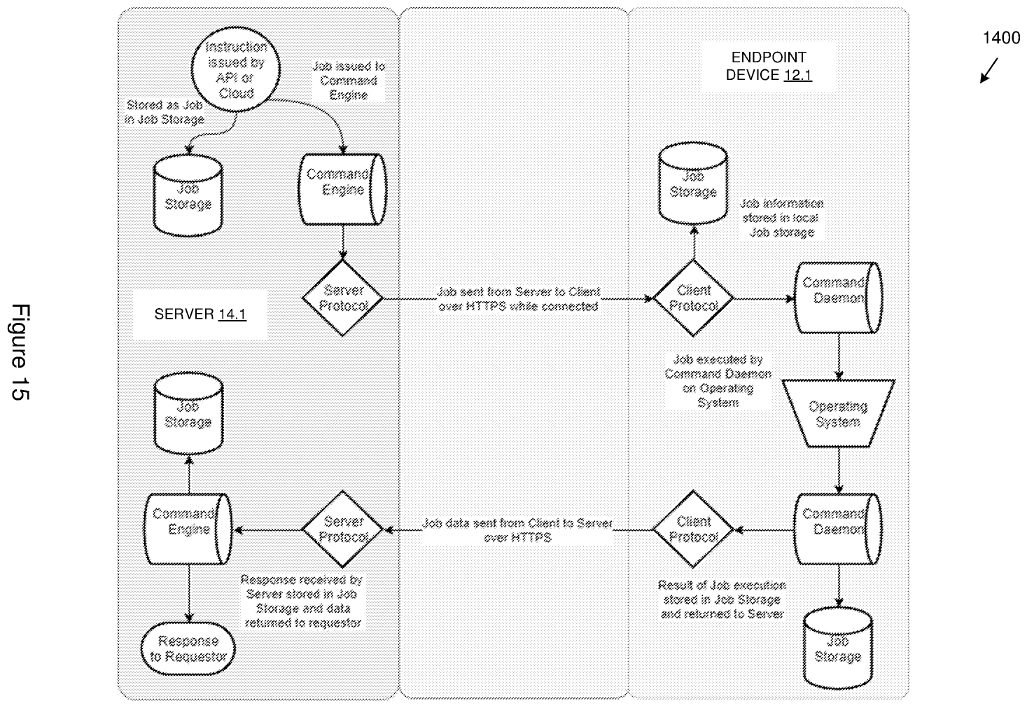

FIG. 14 shows an example flow diagram of an example of how the systems described herein may handle interruptions in connectivity between the server computer (14.1) and the endpoint device (12.1).

Below are examples of commands that may be executed, and how the commands may be used to monitor or control devices or applications:
Return the status of a particular service running on a server: “ps -ef | grep haproxy”
   This may validate whether or not the haproxy process is currently running on the Linux™-based system;
   This may be required for ensuring the health of a system, security or troubleshooting;
A connection from the server to a desired target may be verified: “ping -c 5 8.8.8.8”
   This may validate, depending on the output, whether or not the system can connect via PING, for example to a Google™ DNS server, and may indicate that successful networking is in place;
   This could also be used to validate connections internal to a data centre;
   Ping may provide a simple tool to validate a connection as well as determine a base-line metric for latency between the two interfaces of a connection;
Start service on server: “service start haproxy”
   Various services exist on systems that the client interface (18.1) may be installed on, and these services can be managed through simple execute commands with the systems and methods disclosed herein, over the protocol via the server (14.1).
   If it is found that the “haproxy” service is not running, the server may issue a start command to get the “haproxy” into a needed state, i.e. to get it running.
Stop server on server: “service stop haproxy”
   In this case, an issue may be identified in haproxy and may require turning it off in order to correct the issue.
Write the string “log enabled 1” to the file haproxy.cfg
   If the system (10) is unable to gather enough information about an issue reported in the haproxy application on an endpoint device (12.1) or system, a course of action decided, may be to enable further logging.
Read configuration file “haproxy/haproxy.cfg”
   To ensure that the setting above has been updated correctly, validation of the change by reading back the updated file may be performed.
Transfer of a binary file for updates from server to client
   An update file may need to be sent across the protocol for performance optimizations and security improvements. The server can send the binary file to the client.

In FIG. 15, there is shown a diagram (1400) illustrating an example of how the client interface (18.1) of the endpoint device (12.1) may interact with the server computer (14.1) utilizing HTTPS tunneling.

FIG. 16 shows a diagram (1500) showing incremental intervals that may be utilized by the client interface to attempt to reconnect to the server computer once the connection is lost. In the event that the persistent data communication session (40) between the client interface (18.1) and the server computer (14.1) loses connection, the client interface may attempt to reconnect to the server (14.1) in incremental intervals of about 1 second up to a maximum of about 10 seconds, however other intervals may be used if needed.

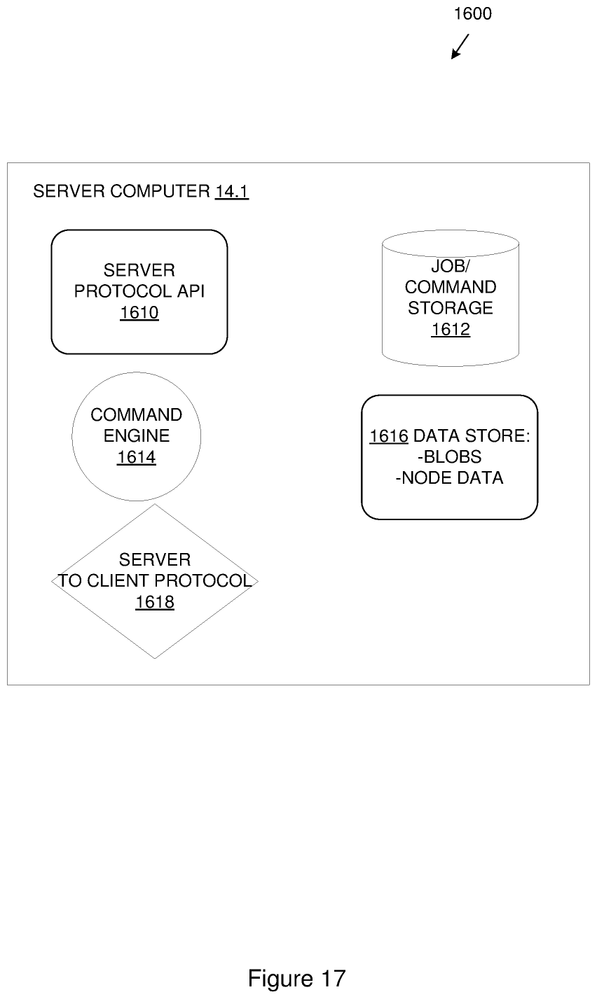

FIG. 17 shows an exemplary block diagram (1600) illustrating various exemplary components that may form part of the server computer (14.1), including a server protocol API (1610); a job or command storage database (1612); a command engine (1614); a data store (1616) for example for blobs of data and node data; and a server to client protocol (1618) may be provided.

The protocol utilized may provide a communication method used between the client (18.1) and the server (14.1). An API may be available for functionality for the server, client and the protocol used. A Job may be a set of instructions (32) sent by the server (14.1) to the client (18.1) for execution. Job information may be stored in a Job Storage (1612) facility or database on both the server (14.1) and the endpoint device (12.1) or client. Jobs may include:
Write a file
Read a file
Run or execute an instruction or command

Further features of the system may include the following:
A RESTful API (1610) may be utilized for server communication. A schematic example of the REST API (50) is also shown in FIG. 1:
   All server functionality may be available via API
   Connections to the API may be available through HTTPS only with pre-shared authentication
Job Storage (1612)
   Storage entries may be provided for Job information:
      Already executed,
      Currently being executed, and
      Scheduled for execution
   A current state of each Job and (if needed) job interval and start time
Command Engine (1614)
   The Command Engine (1614) may manage all Jobs sent to each client interface as well as the responses received back from the client interfaces.
   Data may be written to the Job Storage database (1612)
A Data Store (1616) may be provided
   A key value store may be provided for text and binary data compatible with the way that the server keeps nodes in memory;
   Information may be fetched and stored at high-speed in large quantities;
   Shared storage for node credentials;
Server to Client Protocol (1618)
   Connection manager may be provided for all connections received from allowed clients or endpoint devices (12.1 to 12.n);
   Job information may be sent and received over HTTPS to and from the client interfaces (18.1 to 18.n)

Binary Safe Transfers

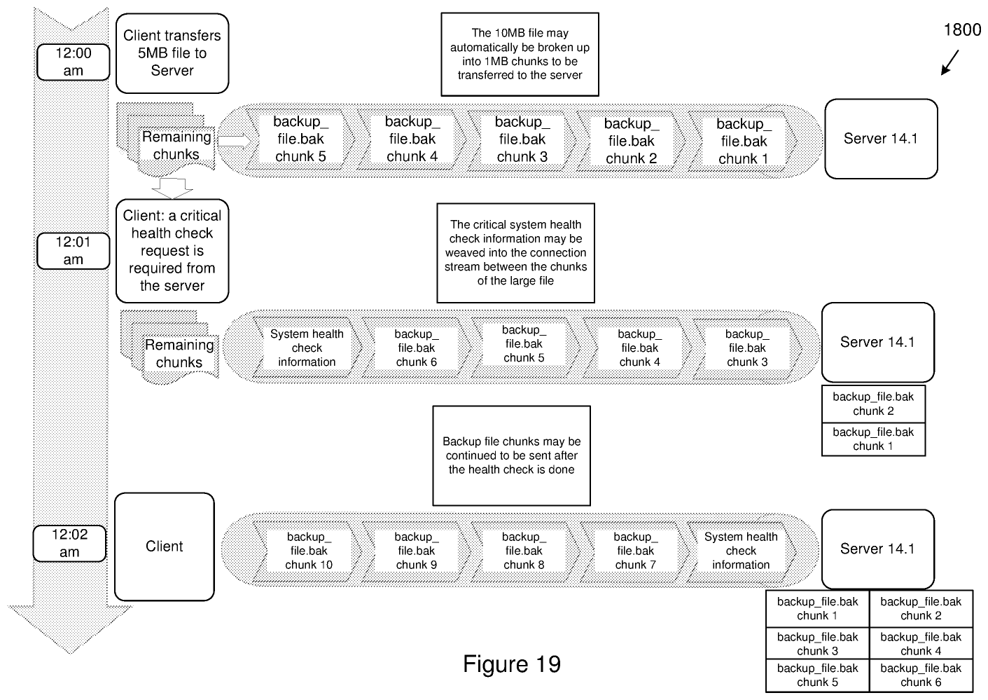

The systems and methods described herein may transfer data using the protocol, which may be a binary safe communication standard that allows very efficient transfer of data, for example in two primary ways:
1. Large files: these may be chunked (see below and FIG. 19) and compressed due to the protocol being binary-safe.
2. Small data sets: Typical communication methods that are JavaScript Object Notation (JSON) based (or JSON-like) may consume more data to describe the field than the value of the field. The system, method and protocol disclosed herein may encode this data to a binary stream which then uses as little data and computing power as possible.

Multiple Connections Between Server Vs Client

The systems methods and protocol disclosed may support the ability to open multiple channels or persistent data communication sessions (40). Several outbound connections to the servers (14.1 to 14.n) may be utilized in order to have substantially parallel instruction sets. This may allow threaded client interfaces (18.1 to 18.n) to accept jobs on an event-based system and to run multiple tasks in parallel.

Connection Efficiency

Establishing a secure communication channel may be a computationally expensive task. The negotiation of a new HTTPS, SSH, etc channel may require public key negotiations which all apply a factor of 10-200 times more load than using an existing channel that is already negotiated and secured. The systems and methods disclosed herein may maintain a connection or communication session (40) once established, in order to communicate in the most power, computing and latency efficient method possible while it may ensure that communications are cryptographically secure.

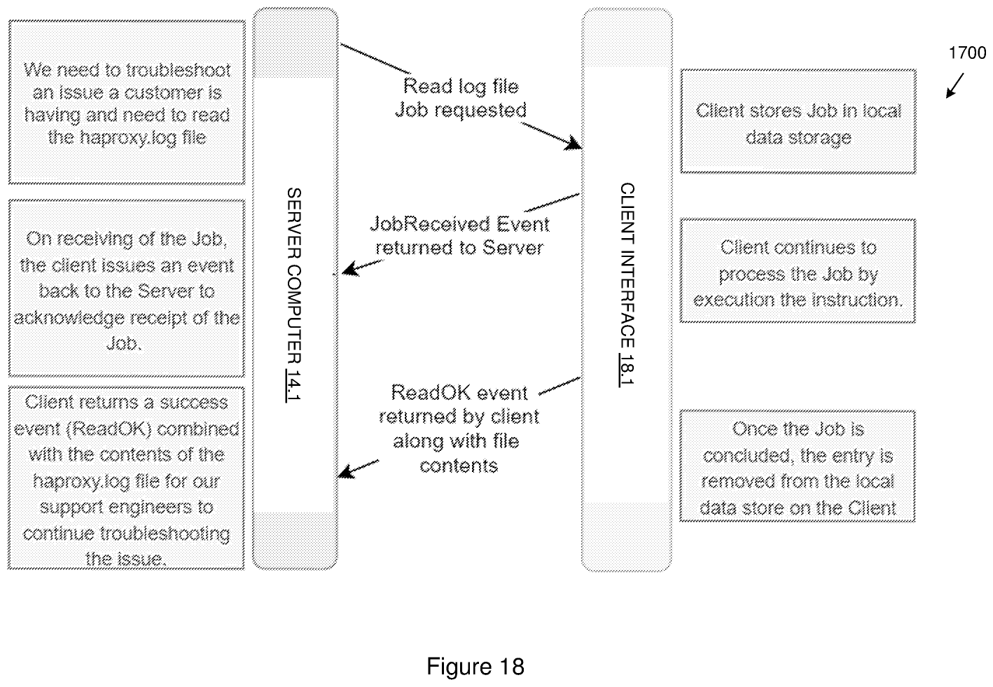

Referring to FIG. 18, there is shown a diagram (1700) showing an example of how the system may handle jobs to be performed by endpoint devices (18.1 to 18.n), as well as events that may be communicated back to the server computer(s) (14.1 to 14.n).

Jobs and Event Communication

The communication between the server and client may be provided by using two operators, namely job (or command) and event.

A Job may be a work instruction (32) sent from the Server to the Client, from which at least 2 Events may occur. The first may be a job received event to acknowledge that the client has received the job, the second may be a result of the client attempting to execute the job. Depending on the type of work being done, more events may be triggered, for example a recurring job may trigger an event every time it is run. Events may also be where any errors and timeouts are noted back to the server. The client may for example not be able to execute a job, without specific instructions from the server, and may be under a “contract” or obligation to always return an event from a received job. These features are illustrated in the diagram (1700) in FIG. 18.

Data Store

The system may have an asynchronous contract based storage system on each node in the network (for example on each endpoint device), as well as at the server. These contracts may facilitate that for every action there is a reaction i.e. every job has one or more associated events with it. The client may store any events that have not synced to the server (due to loss of connection, delay, etc) until the contract is completed. This data may be American Standard Code for Information Interchange (ASCII codes) or binary information which may be kept in sync automatically between all the nodes and the server, and stored securely by the server.

Usage of Chunks and Splicing to Attain Concurrency

In FIG. 19 there is shown a diagram (1800) that shows how data may be transmitted in chunks from the client interface of the endpoint device (e.g. endpoint device (12.1)) to the server computer (e.g. server computer (14.1)). This may be referred to as a chunking process (1800).

In order to prevent long-running instructions between the server and the client from holding up concurrent instructions, large files or payloads may automatically be split into similar size chunks for data transfer across the persistent data communication session (40).

In the example illustrated in FIG. 19, a backup file is transferred from the client to the server which may for example be 10 megabytes (MB) in size. This file may then be broken down into ten 1 megabyte chunks. Mid-way through the transfer of chunks, a high priority instruction may be required by the server to return health information of the client or client system or endpoint device. The system health job may then be weaved into the connection stream between the backup file chunks.

This chunking mechanism may provide advantages.
From the engineer or system managing the server, it may emulate a concept of concurrency, as two instructions may be processed through a single connection without the second instruction having to wait for the first to complete;
If there is a connection interruption during a large file transfer, there may be less chance of data corruption and the transfer may continue once the connection has been re-established; and
In IoT use case a “large file” may be a small file that takes a long time to transmit due to poor connectivity, etc. The automatic chunking behavior may ensure that concurrency may be preserved even when transferring a single command response over a relatively long time.

Referring again to FIG. 1, the endpoint devices may for example be ADC servers or nodes that connect out to the server (14.1). This may facilitate changing IP addresses to not affect functionality of the system (10) (E.g. Devices on ADSL or 4G with IP's that can change at irregular times). This may provide the following advantages:
Connecting out means that typically there is no need to change any firewall rules or configuration settings;
The server side does not need access to or need to configure the details of the client (IP:PORT);
Clients may be automatically deployed clients because they appear when they come online;
If the endpoint device changes its networking configuration or moves physical location it may not have any effect on the system (10);
This may enable wide-scale anonymous IoT reporting and control;
unnecessary duplicate messages may not be required (single authentication for the communication session);
Endpoint devices may be persistently connected not polling or on a schedule, and thousands or even millions of devices may be controlled concurrently;
Contracts may be used between two computer systems, meaning that for every action there may be a reaction and for every job there may be a guarantee;
This may allow data certainty for mission critical instructions;
Scheduling may allow accounting for the fact that connection windows may occur but more regular work may be required;
Loss in connectivity need not obstruct the execution of jobs and endpoint devices can catch up when connectivity is restored;
This may allow time-based schedules to continue and live jobs to resume;
The system may be as resilient as possible to non-optimal conditions. EG. A smart car driving out of reception will still continue to perform jobs or instructions offline and transmit results once connectivity is restored;
The system may be able to run on any hardware and any operating system. In other words, the system may be Device or Software or Application agnostic;
Data compression may be used by the system, for example during the persistent data communication session; Chunking (E.G. FIG. 19) may also utilize compression of the various data chunks or parts;
The chunking may allow bi-directional communication with only a single session;
   A single client may also connect to a single server;
The systems and methods described may provide for less energy usage, both at the server side and on the client side. This may provide less battery usage for example, and may provide features in mobile devices that was not previously possible;
Shared Resource system may be provided that manages a set of connection details between server and client; and
The Command Engine (e.g. shown in FIG. 17) may be threaded, may keep a local state, and may implement a contract.

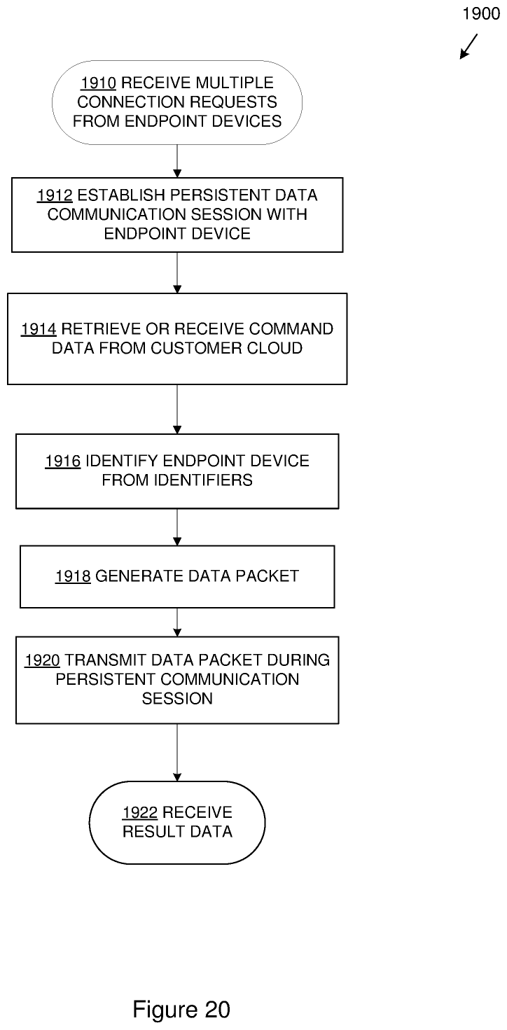

FIG. 20 is a high-level flow diagram illustrating an exemplary method (1900) of controlling a plurality of endpoint devices. The method (1900) may be conducted at a server computer such as server computer (14.1) (or via the cloud). The method may comprise receiving (1910), by the server computer (14.1), multiple connection requests (20) that each originate from an endpoint device (12.1 to 12.n), each endpoint device (12.1) having a client interface (18.1 to 18.n) thereat that generates the connection request (20) as an outbound connection request from the endpoint device (12.1 to 12.n) to the server computer (14.1). The method may further include establishing (1912), by the server computer (14.1), a persistent data communication session (40) between the server computer (14.1) and the client interface (18.1) of each endpoint device (12.1). The method may further include receiving or retrieving (1914), through a control interface (26.1) of the server computer (14.1), command data (28) to control one or more of the endpoint devices (12.1 to 12.n) (the command data may be received from a customer (30)), the command data (28) including endpoint device instructions (32) and endpoint device identifiers (34). The method (1900) may further include, for each endpoint device identified (1916) by the received endpoint device identifiers: generating (1918), by the server computer (14.1), a data packet (43.1) which may include the command data (28). The method may yet further include transmitting (1920), by the server computer (14.1), the data packet (43.1) via the persistent data communication session (40) to the client interface (18.1) of the endpoint device (12.1), to enable the endpoint device instructions (32) to be carried out by the endpoint device (12.1). The method may yet further include receiving (1922), by the server computer (14.1), result data (46.1) from the client interface (18.1) of the endpoint device (12.1) once the instructions are carried out.

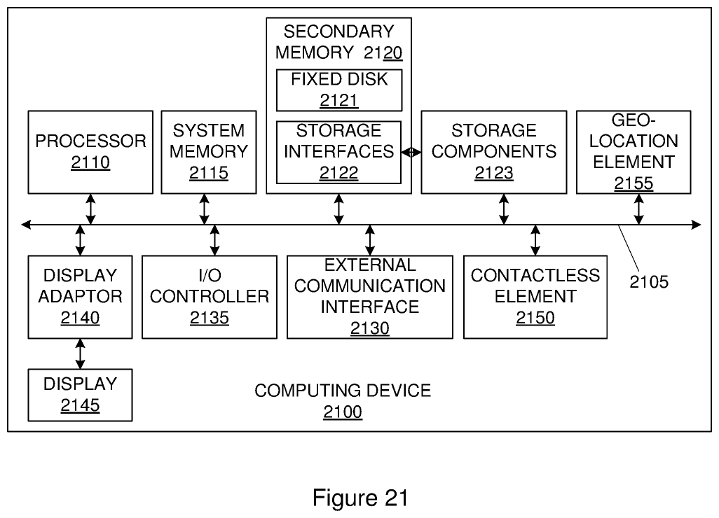

FIG. 21 illustrates an example of a computing device (2100) in which various aspects of the disclosure may be implemented. The computing device (2100) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (2100) may be suitable for storing and executing computer program code. The various participants and elements in the previously described system diagrams may use any suitable number of subsystems or components of the computing device (2100) to facilitate the functions described herein. The computing device (2100) may include subsystems or components interconnected via a communication infrastructure (2105) (for example, a communications bus, a network, etc.). The computing device (2100) may include one or more processors (2110) and at least one memory component in the form of computer-readable media. The one or more processors (2110) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (2100) may be distributed over a number of physical locations (e.g. in a distributed, cluster or cloud-based computing configuration) and appropriate software units may be arranged to manage and/or process data on behalf of remote devices.

The memory components may include system memory (2115), which may include read only memory (ROM) and random-access memory (RAM). A basic input/output system (BIOS) may be stored in ROM. System software may be stored in the system memory (2115) including operating system software. The memory components may also include secondary memory (2120). The secondary memory (2120) may include a fixed disk (2121), such as a hard disk drive, and, optionally, one or more storage interfaces (2122) for interfacing with storage components (2123), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (2100) may include an external communications interface (2130) for operation of the computing device (2100) in a networked environment enabling transfer of data between multiple computing devices (2100) and/or the Internet. Data transferred via the external communications interface (2130) may be in the form of signals, which may be electronic, electromagnetic, optical, radio, or other types of signal. The external communications interface (2130) may enable communication of data between the computing device (2100) and other computing devices including servers and external storage facilities. Web services may be accessible by and/or from the computing device (2100) via the communications interface (2130).

The external communications interface (2130) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (2130) may include a subscriber identity module (SIM) in the form of an integrated circuit that stores an international mobile subscriber identity and the related key used to identify and authenticate a subscriber using the computing device (2100). One or more subscriber identity modules may be removable from or embedded in the computing device (2100).

The external communications interface (2130) may further include a contactless element (2150), which is typically implemented in the form of a semiconductor chip (or other data storage element) with an associated wireless transfer element, such as an antenna. The contactless element (2150) may be associated with (e.g., embedded within) the computing device (2100) and data or control instructions transmitted via a cellular network may be applied to the contactless element (2150) by means of a contactless element interface (not shown). The contactless element interface may function to permit the exchange of data and/or control instructions between computing device circuitry (and hence the cellular network) and the contactless element (2150). The contactless element (2150) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (2100) and an interrogation device. Thus, the computing device (2100) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (2110). A computer program product may be provided by a non-transient computer-readable medium, or may be provided via a signal or other transient means via the communications interface (2130).

Interconnection via the communication infrastructure (2105) allows the one or more processors (2110) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (2100) either directly or via an I/O controller (2135). One or more displays (2145) (which may be touch-sensitive displays) may be coupled to or integrally formed with the computing device (2100) via a display (2145) or video adapter (2140).

The computing device (2100) may include a geographical location element (2155) which is arranged to determine the geographical location of the computing device (2100). The geographical location element (2155) may for example be implemented by way of a global positioning system (GPS), or similar, receiver module. In some implementations the geographical location element (2155) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (2100). In some implementations, the geographical location element (2155) may implement inertial navigation to track and determine the geographical location of the communication device using an initial set point and inertial measurement data.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The foregoing description has been presented for the purpose of illustration; it is not intended to be exhaustive or to limit the disclosure to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

Finally, throughout the specification and accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for controlling a plurality of endpoint devices, the method being conducted at a server computer, the method comprising:
receiving, by the server computer, multiple connection requests, each connection request originating from an endpoint device, each endpoint device having a client interface thereat that generates the connection request as an outbound connection request from the endpoint device to the server computer;
establishing, by the server computer, a persistent data communication session between the server computer and the client interface of each endpoint device;
receiving, through a control interface of the server computer, command data to control one or more of the endpoint devices, the command data including endpoint device instructions and endpoint device identifiers;
for each endpoint device identified by the received endpoint device identifiers:
generating, by the server computer, a data packet including the command data;
transmitting, by the server computer, the data packet via the persistent data communication session to the client interface of the endpoint device, to enable the endpoint device instructions to be carried out by the endpoint device; and
receiving, by the server computer, result data from the client interface of the endpoint device once the instructions are carried out.

2. The method as claimed in claim 1, wherein the client interface of each endpoint device is configured, once a connection between the client interface and the server computer is lost, to automatically transmit another outbound connection request for the server computer to re-establish the persistent data communication session.

3.-5. (canceled)

6. The method as claimed in claim 1, wherein data is transferred to the endpoint device during the persistent data communication session, using a chunking process.

7. (canceled)

8. (canceled)

9. The method as claimed in claim 1, wherein the method includes: encrypting, by the server computer, the data packet, and causing the client interface of the endpoint device to decrypt the data packet, and wherein the method further includes: causing the client interface of the endpoint device to encrypt the result data, and decrypting, by the server computer, the result data when it is received from the client interface of the endpoint device during the persistent data communication session.

10. (canceled)

11. The method as claimed in claim 1, wherein the communication is provided by a communications protocol, and wherein the communications protocol includes a set of rules that governs communications between the server computer and the client interface of each endpoint device, wherein the set of rules includes any one or more of:
that only endpoint device instructions originating from a specific customer are to be carried out by an intended endpoint device or devices;
that the data packet can only be received from the server computer during the persistent data communication session;
that only a data packet received from the server computer and including a unique endpoint device identifier is able to be utilized by that endpoint device;
that the endpoint device is only able to transmit the result data to the server computer if the received data packet includes instructions originating from the server computer; and
that the endpoint device is only able to transmit the result data to the server computer if the result data is a directly derivable result of the endpoint device instructions.

12. (canceled)

13. The method as claimed in claim 1, wherein the method includes: authenticating, by the server computer, the endpoint device before establishing the persistent data communication session with the client interface of that endpoint device, so that subsequent responses and data packets may be sent and received without requiring the persistent data communication session to be re-negotiated.

14. The method as claimed in claim 13, wherein the authentication process is performed in less than a second, alternatively, in less than 500 milliseconds, alternatively in about 150 milliseconds.

15. The method as claimed in claim 2, wherein the client interface of the endpoint device is configured, if the data packet is received and the persistent data communication session is subsequently terminated, to nevertheless cause the endpoint device to carry out the endpoint device instructions, and then to transmit the result data once the persistent data communication session is re-established.

16. (canceled)

17. The method as claimed in claim 1, wherein the server computer forms part of, or is connected to a customer cloud infrastructure that includes a plurality of other server computers, and wherein the method includes implementing, by the server computer or the customer cloud infrastructure, a machine learning algorithm to react in near real-time to result data received from one or more of the plurality of endpoint devices.

18. The method as claimed in claim 1, wherein the client interface of each endpoint device is a thin client, wherein the control interface of the server computer is a thin server, wherein the thin client occupies less than 100 megabytes, alternatively less than 10 megabytes of storage space on a memory associated with each endpoint device, and wherein the thin server occupies less than 100 megabytes, alternatively less than 10 megabytes of storage space on a memory associated with the server computer.

19. A computer-implemented method for controlling a plurality of endpoint devices, the method being conducted at an endpoint device, the method comprising:
providing a client interface at the endpoint device;
generating, by the client interface of the endpoint device, an outbound connection request from the endpoint device to the server computer, to cause the server computer to establish a persistent data communication session between the server computer and the client interface of the endpoint device;
receiving, by the client interface of the endpoint device, a data packet from the server computer via the persistent data communication session, the data packet including command data to control the endpoint device, the command data including endpoint device instructions and an endpoint device identifier;
carrying out the endpoint device instructions, by a processor of the endpoint device; and
transmitting, by the client interface of the endpoint device, result data to the server computer once the instructions are carried out.

20. A system for controlling a plurality of endpoint devices, the system comprising:
a server computer in data communication with the plurality of endpoint devices, each of the endpoint devices including a client interface configured to generate a connection request as an outbound connection request from the endpoint device to the server computer, the server computer including:
a control interface configured to receive command data to control one or more of the endpoint devices, the command data including endpoint device instructions and endpoint device identifiers;
a receiving component for receiving multiple connection requests, each connection request originating from an endpoint device identified by the received endpoint device identifiers, the server computer being operable, responsive to receiving the connection request of each endpoint device, to establish a persistent data communication session between the server computer and the client interface of the endpoint device;
a data packet generation component for generating a data packet including the command data;
a data packet transmitting component operable to transmit the data packet via the persistent data communication session to the client interface of each endpoint device identified by the endpoint device identifiers, to enable the endpoint device instructions to be carried out by the endpoint device.

21. (canceled)

22. The system as claimed in claim 20, wherein the client interface of each endpoint device is configured, once a connection between the client interface and the server computer is lost, to automatically transmit another outbound connection request for the server computer to re-establish the persistent data communication session.

23.-25. (canceled)

26. The system as claimed in claim 20, wherein data is transferred to the endpoint device during the persistent data communication session, using a chunking process.

27. (canceled)

28. (canceled)

29. The system as claimed in claim 20, wherein the server computer is configured to encrypt the data packet, and wherein the client interface of the identified endpoint device is configured to decrypt the data packet.

30. The system as claimed in claim 20, wherein the system includes a result analytics component provided at the server computer, the result analytics component being operable to analyze result data received by the receiving component from the client interface of the endpoint device, once the instructions are carried out, wherein the communication is provided by a communications protocol, wherein the communications protocol includes a set of rules that governs communications between the server computer and the client interface of each endpoint device, and wherein the set of rules includes any one or more of:
that only endpoint device instructions originating from a specific customer are to be carried out by an intended endpoint device or devices;
that the data packet can only be received from the server computer during the persistent data communication session;
that only a data packet received from the server computer and including a unique endpoint device identifier is able to be utilized by that endpoint device;
that the endpoint device is only able to transmit the result data to the server computer if the received data packet includes instructions originating from the server computer; and
that the endpoint device is only able to transmit the result data to the server computer if the result data is a directly derivable result of the endpoint device instructions.

31. (canceled)

32. The system as claimed in claim 20, wherein the server computer is configured to authenticate the endpoint device before establishing the persistent data communication session with the client interface of that endpoint device, so that subsequent responses and data packets may be sent and received without requiring the persistent data communication session to be re-negotiated.

33. The system as claimed in claim 32, wherein the authentication process is performed in less than a second, alternatively, in less than 500 milliseconds, alternatively in about 150 milliseconds.

34. The system as claimed in claim 20, wherein the system includes a result analytics component provided at the server computer, the result analytics component being operable to analyze result data received by the receiving component from the client interface of the endpoint device, once the instructions are carried out, and wherein the client interface of the endpoint device is configured, if the data packet is received and the persistent data communication session is subsequently terminated, to nevertheless cause the endpoint device to carry out the endpoint device instructions, and then to transmit the result data once the persistent data communication session is re-established.

35. (canceled)

36. (canceled)

37. The system as claimed in claim 20, wherein the client interface of each endpoint device is a thin client, wherein the control interface of the server computer is a thin server, wherein the thin client occupies less than 100 megabytes, alternatively less than 10 megabytes of storage space on a memory associated with each endpoint device, and wherein the thin server occupies less than 100 megabytes, alternatively less than 10 megabytes of storage space on a memory associated with the server computer.

38.-55. (canceled)
